(19) United States
(12) Patent Application Publication
(10) Pub. No.: US 2014/0222454 A1
(43) Pub. Date: Aug. 7, 2014

(54) Systems and Methods That Administer a Health Improvement Program and an Adjunct Medical Treatment

(71) Applicants: Sean Patrick Duffy, San Francisco, CA (US); Andrew Paul DiMichele, San Francisco, CA (US); Adrian Benton James, Oakland, CA (US)

(72) Inventors: Sean Patrick Duffy, San Francisco, CA (US); Andrew Paul DiMichele, San Francisco, CA (US); Adrian Benton James, Oakland, CA (US)

(21) Appl. No.: 14/245,961

(22) Filed: Apr. 4, 2014

Related U.S. Application Data
(63) Continuation-in-part of application No. 13/668,644, filed on Nov. 5, 2012.
(60) Provisional application No. 61/555,455, filed on Nov. 3, 2011.

(51) Int. Cl. G06F 19/00

(52) U.S. Cl. CPC G06F 19/3481; G06F 19/3431
USPC 705/2

(57) ABSTRACT

Systems and methods that administer a health improvement program and an adjunct medical treatment are provided herein. A method includes tracking performance of a participant in a health improvement program, the health improvement program designed to improve the health condition of the participant, comparing the performance of the participant to a minimum threshold requirement that signals that the participant is not adequately improving under the health improvement program, identifying when the performance of the participant falls below the minimum threshold level, and when the performance of the participant falls below the minimum threshold level, outputting a message to at least one of the participant or a third party that the participant is a potential candidate for an adjunct medical treatment.

### CROSS REFERENCE TO RELATED APPLICATIONS

This application is a continuation-in-part of U.S. Non-Provisional application Ser. No. 13/668,644, titled “METHOD AND SYSTEM FOR SUPPORTING A HEALTH REGIMEN”, filed on Nov. 5, 2012, which claims the benefit of U.S. Provisional Application No. 61/555,455, titled “Method and User Interface for Supporting a Health Regimen” filed on Nov. 3, 2011, all of which are hereby incorporated by reference herein in their entireties including all references cited therein.

### FIELD OF THE INVENTION

The present technology is generally directed to health improvement technologies, and more specifically, but not by way of limitation, to systems and methods for improving the health of participants in a group program in such a way that a maximum number of participants complete the group program and achieve a common health goal. These systems and methods include a synchronous start time for the participants in the group program, as well as performance tracking of individual sub-program completion by participants.

### BACKGROUND

It is well known that people with excess body weight (e.g. body fat) have increased risk of health problems, such as diabetes and cardiovascular disease. Medical professionals generally advise overweight or obese patients to lower their risk of health complications by losing excess weight. For example, people with pre-diabetes (a condition in which glucose levels are higher than normal but are not high enough for a diagnosis of diabetes) can delay or lower their risk of developing diabetes by losing a modest amount of weight through dietary changes and increased physical activity. However, despite general guidelines such as improved diet or increased exercise, it may be difficult for many to effectively lose weight. Generic guidelines may not be suitable or useful for certain individuals, and many may not have access to personal nutritionists or trainers. Drastic lifestyle changes are often difficult to implement, and may contribute to lost motivation that hampers effective weight loss. Thus, there is a need in the medical field to create an improved method and user interface for supporting a health regimen. This invention provides such an improved method, system, and user interface.

### SUMMARY

According to some embodiments, the present technology is directed to a method for managing a health condition by using a health program server that comprises a processor and a memory for storing logic that is executed by the processor to perform the method. In some embodiments the method comprises: (a) tracking performance of a participant in a health improvement program, the health improvement program designed to improve the health condition of the participant; (b) comparing the performance of the participant to a minimum threshold requirement that signals that the participant is not adequately improving under the health improvement program; (c) identifying when the performance of the participant falls below the minimum threshold level; and (d) when the performance of the participant falls below the minimum threshold level, outputting a message to at least one of the participant or a third party that the participant is a potential candidate for an adjunct medical treatment.

According to some embodiments, the present technology is directed to a method for improving a health condition by using a health program server that comprises a processor and a memory for storing logic that is executed by the processor to perform the method. The method may comprise: (a) enrolling a participant in an online health improvement program managed by the health improvement program server, the participant having a biometric parameter in a predetermined range indicative of a future adverse physical medical condition if the biometric parameter remains in the predetermined range or advances into an advanced predetermined range indicative of a higher probability of development of the future adverse physical medical condition; (c) providing to the participant after the enrolling an exercise to be performed by the participant, the exercise designed to improve the biometric parameter if performed by the participant on a frequency designated by the online health improvement program; (d) receiving after the enrolling a measurement of the participant's biometric parameter; (e) receiving after the enrolling a response from the participant to the exercise; (f) correlating the measurement to the response and determining if the biometric parameter remains in the predetermined range, or has advanced into the advanced predetermined range indicative of a higher probability of development of the future adverse physical medical condition, or has improved into an improved predetermined range indicative of a lower probability of development of the future adverse medical condition; and (g) administering an adjunct medical treatment to the participant if the participant's biometric parameter has advanced into the advanced predetermined range indicative of a higher probability of development of the future adverse physical medical condition.

According to some embodiments, the present technology is directed to a method for improving a health condition by using a health program server that comprises a processor and a memory for storing logic that is executed by the processor to perform the method. The method may comprise: (a) enrolling a participant in an online health improvement program managed by the health improvement program server, the participant having a biometric parameter in a predetermined range indicative of a future adverse physical medical condition if the biometric parameter remains in the predetermined range or advances into an advanced predetermined range indicative of a higher probability of development of the future adverse physical medical condition, and the participant receiving an adjunct medical treatment designed to improve the biometric parameter if used by the participant per a treatment plan; (b) providing to the participant after the enrolling an exercise to be performed by the participant, the exercise designed to improve the biometric parameter if performed by the participant on a frequency designated by the online health improvement program; (c) providing to the participant after the enrolling a question to be answered by the participant, the question designed to determine if the participant is complying with the treatment plan for the adjunct medical treatment; (d) receiving after the enrolling a measurement of the participant's biometric parameter; (e) receiving after the enrolling a response from the participant to the exercise; (f) receiving after the enrolling an answer from the participant about complying with the treatment plan for the adjunct medical treatment; (g) correlating the measurement, the response, and the answer, and determining if the biometric parameter remains in the predetermined range, or has advanced into the advanced predetermined range indicative of a higher probability of development of the future adverse physical medical condition, or has improved into an improved predetermined range indicative of a lower probability of development of the future adverse medical condition; (h) if the biometric parameter has changed ranges, further determining whether the change of ranges is caused by the exercise, the adjunct medical treatment or a combination thereof; and (i) if the change of ranges is a change to the improved predetermined range indicative of a lower probability of development of the future adverse medical condition, and the change is caused by the exercise, halting the administering of the adjunct medical treatment.

According to some embodiments, the present technology may be directed to a method for improving a health condition by using a health program server that comprises a processor and a memory for storing logic that is executed by the processor to perform the method. The method may comprise: (a) enrolling a participant in an online health improvement program managed by the health improvement program server, the participant having a biometric parameter in a predetermined range indicative of a future adverse physical medical condition if the biometric parameter remains in the predetermined range or advances into an advanced predetermined range indicative of a higher probability of development of the future adverse physical medical condition, and the participant receiving an adjunct medical treatment designed to improve the biometric parameter if used by the participant per a treatment plan; (b) providing to the participant after the enrolling an exercise to be performed by the participant, the exercise designed to improve the biometric parameter if performed by the participant on a frequency designated by the online health improvement program; (c) providing to the participant after the enrolling a question to be answered by the participant, the question designed to determine if the participant is complying with the treatment plan for the adjunct medical treatment; (d) receiving after the enrolling a measurement of the participant's biometric parameter; (e) receiving after the enrolling a response from the participant to the exercise; (f) receiving after the enrolling an answer from the participant about complying with the treatment plan for the adjunct medical treatment; (g) correlating the measurement, the response, and the answer, and determining if the biometric parameter remains in the predetermined range, or has advanced into the advanced predetermined range indicative of a higher probability of development of the future adverse physical medical condition, or has improved into an improved predetermined range indicative of a lower probability of development of the future adverse medical condition; (h) if the biometric parameter has changed ranges, further determining whether the change of ranges is caused by the exercise, the adjunct medical treatment or a combination thereof; and (i) if the change of ranges is a change to the improved predetermined range indicative of a lower probability of development of the future adverse medical condition, and the change is caused by the exercise, halting the administering of the adjunct medical treatment.

According to some embodiments, the present technology may be directed to a method for slowing down or reversing an onset of diabetes by using a health program server that comprises a processor and a memory for storing logic that is executed by the processor to perform the method, which comprises: (a) enrolling a participant in an online health improvement program managed by the health improvement program server, the participant having a blood sugar measurement in a predetermined range indicative of the future development of diabetes if the blood sugar measurement remains in the predetermined range or advances into an advanced predetermined range indicative of a higher probability of the future development of diabetes, and the participant receiving an adjunct medical treatment designed to improve the blood sugar measurement if used by the participant per a treatment plan; (b) providing to the participant after the enrolling an exercise to be performed by the participant, the exercise designed to improve the blood sugar measurement if performed by the participant on a frequency designated by the online health improvement program; providing to the participant after the enrolling a question to be answered by the participant, the question designed to determine if the participant is complying with the treatment plan for the adjunct medical treatment; (c) receiving after the enrolling a measurement of the participant's blood sugar; (d) receiving after the enrolling a response from the participant to the exercise; (e) receiving after the enrolling an answer from the participant about complying with the treatment plan for the adjunct medical treatment; (f) correlating the measurement, the response, and the answer, and determining if the blood sugar measurement remains in the predetermined range, or has advanced into the advanced predetermined range indicative of a higher probability of the future development of diabetes, or has improved into an improved predetermined range indicative of a lower probability of the future development of diabetes; (g) if the blood sugar measurement has changed ranges, further determining whether the change of ranges is caused by the exercise, the adjunct medical treatment or a combination thereof; and (h) if the change of ranges is a change to the improved predetermined range indicative of a lower probability of the future development of diabetes, and the change is caused by the exercise, halting the administering of the adjunct medical treatment.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIGS. 1 and 2 are schematics of an embodiment of a method for supporting a health regimen of a preferred embodiment;

FIG. 3 is a schematic of an example of filtering measurement data in the method of a preferred embodiment;

FIGS. 4A and 4B are examples of determining trends of the body metric measurements of a participant and of a matched group;

FIG. 5A depicts an embodiment of a user interface for supporting a health regimen;

FIG. 5B is an example of a home page in an example embodiment of a user interface for supporting a health regimen;

FIG. 6 is an example of a profile page in an example embodiment of a user interface for supporting a health regimen;

FIG. 7 is an example of a progress page in an example embodiment of a user interface for supporting a health regimen;

FIG. 8 is an example group page in an example embodiment of a user interface for supporting a health regimen;

FIGS. 9A and 9B are example communications between participants in an example embodiment of a user interface comprising a message client;

FIG. 10 is an example curriculum page in an example embodiment of a user interface for supporting a health regimen;

FIG. 11 is an example communication between a facilitator and a participant in an example embodiment of a user interface for supporting a health regimen;

FIG. 12 is a second example of a profile page in a second example embodiment of a user interface for supporting a health regimen;

FIG. 13 is a second example of a group page in a second example embodiment of a user interface for supporting a health regimen;

FIG. 14 is a second example of a curriculum page in a second example embodiment of a user interface for supporting a health regimen;

FIG. 15 is a sample health regimen curriculum scheme based on a diabetes prevention program;

FIG. 16 depicts an embodiment of a system for supporting a health regimen;

FIG. 17 is schematic diagram of an exemplary architecture that includes a health program tracking system for practicing aspects of the present technology;

FIG. 18 is a flowchart of an exemplary method for managing a health condition by using a health program server;

FIG. 19 is a flowchart of an exemplary sub-method that includes determining the performance of the participant in a health improvement program relative to a predetermined standard;

FIG. 20 is a flowchart of a method of the present technology that specifically relates to the use and measurement of an efficiency biomarker;

FIG. 21 is a flowchart of another exemplary method for improving a health condition by using a health program server;

FIG. 22 is a flowchart of another method for improving a health condition using a combination of a health improvement program and adjunct medical treatment;

FIG. 23 is a flowchart of a method for slowing down or reversing an onset of diabetes; and

FIG. 24 illustrates an exemplary computing system that may be used to implement embodiments according to the present technology.

### DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

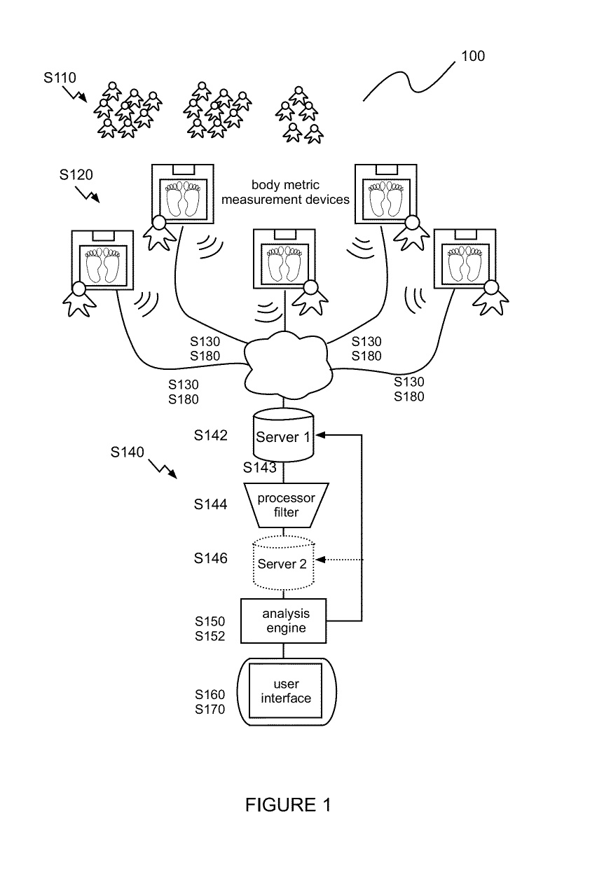

As shown in FIG. 1, in a preferred embodiment, the method 100 for supporting a health regimen includes the steps of: grouping a plurality of participants into a matched group S110; providing, to each participant of the matched group, a body metric measurement device configured to communicate remotely with a network S120; receiving a set of body metric measurement data S130 over the network from a participant and a portion of the participants of the matched group S130; storing the set of body metric measurement data S140 on a server; determining a body metric measurement trend of the participant S150; determining a body metric measurement trend of the portion of the matched group S152; and providing feedback to the participant S160 based on the body metric measurement trend of the participant relative to the body metric measurement trend of the portion of the matched group S160. The method 100 may further include providing, to each participant of the matched group, a health regimen curriculum S170, and providing a physical motivational incentive to the participant S180. A facilitator leading the matched group and/or the participants in the matched group may provide feedback and support tailored to the matched group overall and/or to individual participants in the matched group. At least some of the steps are preferably repeated through the health regimen. In particular, receiving a set of body metric measurement data S130, storing the set of body metric measurement data S140, determining a trend in the body metric measurements of the participant S150, determining a trend of in the body metric measurements of the matched group S152, and providing feedback to the participant S160 are preferably repeated cyclically, and some of these steps may be repeated multiple times within a cycle.

The method 100 is preferably used to facilitate a social environment in which the participants interact with the facilitator and/or one another to more effectively follow a health regimen. In one preferred embodiment, the method 100 is used to help guide participants diagnosed with prediabetes to lose weight to reduce their risk of developing diabetes. In particular, the method may be used to guide participants through the steps outlined in the Diabetes Prevention Program (a research study funded by the National Institute of Diabetes and Digestive and Kidney Diseases). The National Diabetes Prevention Program core curriculum, core session handouts, post-core curriculum, post-core session handouts, and additional materials (National Center for Chronic Disease Prevention and Health Promotion, Diabetes Training and Technical Assistance Center at the Rollins School of Public Health, Emory University) are incorporated herein by reference. In another embodiment, the method 100 is used to help guide participants diagnosed with obesity to lose weight through an exercise and/or diet regimen. Furthermore, in alternative embodiments the method 100 may be used to support health regimens regarding other body metrics, such as BMI, body fat percentage, blood pressure, cholesterol, or other suitable measurements. In variations of the embodiments, the method 100 may be used in a group, support-oriented setting to monitor weight loss or gain in other applications, such as to monitor rapid weight gain indicative of swelling after a diagnosis of congestive heart failure, to monitor unintended weight loss suggestive of paraneoplastic syndrome after a diagnosis of cancer (e.g., prostate or lung cancer), to monitor weight fluctuations after diagnosis of hyper- or hypothyroidism or hyper- or hypoadrenalism (which may indicate, for example, medication dosing errors or changes in the endocrine defect), or to monitor weight trends after diagnosis of eating disorders such as anorexia. In some alternative variations of the embodiments, the method 100 may omit grouping the participants into at least one matched group, such that trends and feedback are determined on an individual basis only.

Grouping a plurality of participants into a matched group S110 functions to establish a community among participants. The participants within a matched group preferably share at least one common goal related to a body metric measurement, such as losing weight, maintaining weight, gaining weight, or reducing body fat percentage, and/or a common goal related to a health condition, such as preventing development of prediabetes to diabetes. Alternatively the participants within a matched group are grouped based on another characteristic. In a preferred embodiment, a matched group includes approximately 8-16 participants, although the matched group may include any suitable number. In another preferred embodiment, a matched group includes approximately 12-18 participants. Grouping a plurality of participants may include one or more variations that cluster participants in similar or the same groups based on various shared characteristics.

In a first variation, grouping a plurality of participants into a matched group S110 includes grouping participants based on a characteristic of a common goal. In a first example of the first variation, the participants within a matched group may share the goal of losing or gaining a certain percentage (e.g. 5%) of an individual respective starting weight or a certain number of pounds. In a second example of the first variation, the participants within a matched group may share the goal of maintaining current starting weight or to attain a particular goal weight. In other examples of the first variation, the participants within a matched group may share the goal of losing, gaining, maintaining, or attaining a particular level or amount of BMI, body fat percentage, or other body metric measurement.

In a second variation, grouping a plurality of participants into a matched group S110 includes grouping participants based on medical history. In a first example of the second variation, participants within a matched group may be diagnosed with a particular condition at approximately the same time (e.g. diagnosed with pre-diabetes within two months of one another, or another suitable threshold). In a second example of the second variation, participants within a matched group may have similar initial body weights, similar initial degree (class or stage) of congestive heart failure or other diagnosis of a cardiovascular disease. In a third example of the second variation, participants within a matched group may be diagnosed with a similar degree of obesity, and in a fourth example of the second variation, participants within a matched group may be diagnosed with a similar stage of osteoarthritis or other joint disease that affects mobility. Other aspects of medical history may be considered in matching participants, such as diagnosis of depression or obsessive-compulsive disorder.

In a third variation, grouping a plurality of participants into a matched group S110 includes grouping participants based on shared personality traits, or similar positions within a personality spectrum. In an example of the third variation, participants within a matched group may have received similar results of a personality test or other assessment. Shared personality traits may include, for instance, optimism, extroversion, openness, agreeableness, or neuroticism. Grouping participants into a matched group may include administering to the participants a standard personality test (e.g. Myers-Brigg personality test, Big Five personality test) or a customized personality test, and clustering participants into matched groups based on the results of the standard or customized personality test.

In a fourth variation, grouping a plurality of participants into a matched group S110 includes grouping participants based on a shared lifestyle characteristic or common interests. In an example of the fourth variation, participants within a matched group may have similar dietary restrictions or preferences (e.g., vegetarianism, veganism, nut-free, gluten-free), marriage status (e.g., married, divorced, widowed, single), children status (e.g. existence, age, gender, number of children), pet status (e.g. existence, age, species, number of pets), religious identification, or other suitable lifestyle characteristic. In another example of the fourth variation, the participants within a matched group may have similar hobbies or other interests (e.g. sports, television shows, cooking).

In a fifth variation, grouping participants into a matched group includes grouping participants based on personal information. In examples of the fifth variation, such personal information may include gender, ethnicity or nationality, age, current geographical area, or occupational field. As another example of the fifth variation, personal information may include hometowns, schools attended, employers, or any suitable personal information.

In additional variations, the step of grouping participants may incorporate any suitable combination of these variations and/or any suitable aspect of the participants. In some embodiments of the method, the participants may additionally and/or alternatively be grouped based on contrasting or complementary aspects, rather than all common traits. For example, participants within a matched group may include both optimists and pessimists, or extroverts and introverts. Furthermore, the step of grouping participants may include weighting one or more of the various characteristics more heavily than others in their importance in the grouping process. For example, grouping participants based on a characteristic of a common goal is preferably weighted more heavily than grouping participants based on personal information.

Grouping a plurality of participants into a matched group S110 may further include sorting the participants using a “tiered” or “staged” process that effectively places the various characteristics in a hierarchy of importance. For instance, in a first stage an initial group of participants may filtered into a second group of participants that exclusively share the goal of losing a particular percentage of their initial respective weights. In a second stage, the second group of participants may be further filtered into a third group of participants that are within a particular age range. In a third stage, the third group of participants may be further filtered into a fourth group of participants that are of the same gender. In this manner, the grouping process may include any suitable number of stages that successively reduce or sort a larger group of participants into smaller matched groups until one or more suitable matched groups are created. In another embodiment, grouping may additionally and/or alternatively include assigning each of the participants a classification or number based on the sorting characteristics and grouping the participants based on their respective classification or number. However, the sorting characteristics may be used to group participants into appropriate matched groups in any suitable manner.

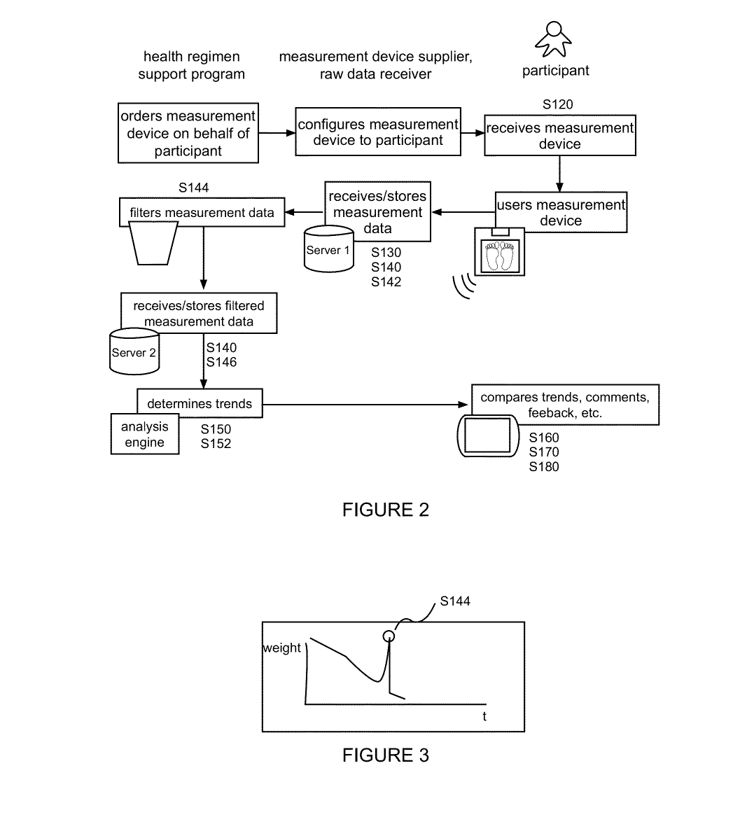

Providing, to each participant of the matched group, a body metric measurement device configured to communicate remotely with a network S120, functions to facilitate measuring a body metric of the participant and to facilitate a manner in which the participants can submit or communicate their body metric measurements (also referred to more simply as “measurements”, “measurement data”, or data points) to a server. Preferably, the body metric measurement device is a weight scale that measures the body weight of a participant. For example, the body metric measurement device may be a BodyTrace™ eScale. In alternative embodiments, the body metric measurement device may be a body fat measuring device (e.g. skinfold caliper), a sphygmomanometer that measures blood pressure, a blood glucose monitor, or any suitable body metric measuring device. Furthermore, the method 100 may further include providing multiple body metric measurement devices (e.g., a weight scale that communicates weight of the participant and a pedometer that communicates number of steps walked by the participant) to each participant of the matched group. Preferably, the body metric measurement device requires no user setup (e.g. calibration and setup performed before the user receives the device, as shown in FIG. 2), but alternatively, minimal setup by the user may be required (e.g. input of identification information prior to device activation). In some embodiments, as shown in FIG. 2, the body metric measurement device may be electronically paired or assigned to a particular participant, such as by linking a product serial number with the name of the participant and storing the link information in a database. The body metric measurement device is preferably configured to communicate over a network such that body metric measurement data may be uploaded to a remote storage, such as through cellular networks (e.g., Global System for Mobile Communications) or over the internet (e.g., Wi-Fi). As shown in FIG. 2, the body metric measurement device is preferably shipped directly to the participant or provided through a retailer, electronic ordering system, or other source to the participant. Preferably, identical models of a body metric measurement device are provided to all participants within a matched group, to maintain consistency and comparability of measurements between participants. Providing identical models of the body metric measurement device may further comprise calibrating all models provided to participants of a matched group, such that they perform consistently in relation to each other. In an alternative embodiment, the step of providing a body metric measurement device may be omitted; for example, instead of a distributor shipping the measurement device to the participants, the participants may be expected to purchase a measurement device on their own at a retailer or other source.

Receiving a set of body metric measurement data S130 over the network from the participant and a portion of the participants of the matched group functions to gather data from which to generate feedback in support of the health regimen. This step is preferably repeated over time such that a time series of body metric measurement data may be received in regular intervals (e.g., hourly, daily, weekly, biweekly) or irregular intervals from the participant and at least one other participant of the matched group. The set of body metric measurement data may further comprise multiple time series of body metric measurement data, the multiple time series of body metric measurement data comprising a time series from the participant, and a time series from each participant of the portion of the matched group. Measurements from the participant and from each participant of the portion of the matched group may be received at the same time or at different times; preferably, measurements from the participant and from each participant in the portion of the matched group are received at the same frequency and/or simultaneously. Alternatively, measurements from the participant and from each participant in the portion of the matched group are received at different frequencies and/or different instances. As described above, the multiple time series are preferably received over a network such as a Global System for Mobile Communication or Wi-Fi. Each body metric measurement in the set of body metric measurement data is preferably labeled with identifying information, such as date, time, and/or location of measurement, personal information identifying the participant being measured, and/or a serial number or other identifier of the body metric measurement device. A time series of measurements is preferably received with push technology, such that the measurement device of a participant initiates transmission of body metric measurement data. However, the time series of measurements may additionally and/or alternatively be received with pull technology, such that the receiver initiates transmission of the body metric measurement (e.g. through polling or manual initiation on the receiver side). A time series of body metric measurements may be received as individual measurements, or as packets or bundles of multiple measurements.

Storing the set of body metric measurement data S140 on a server or other database functions to create and maintain a record of received measurement data from the participant and one or more of the participants of the matched group. Storing the set of body metric measurement data S140 enables the set of body metric measurements, comprising at least one time series of data, to be shared. As shown in FIGS. 1 and 2, storing the set of body metric measurement data preferably includes storing the set of body metric measurement data on a first server S142, receiving the set of data from the first server S143, filtering the received set of data S144, and storing the filtered set of data on a second server S146 for later processing. The first server is preferably a server associated with the storing the raw body metric measurement data directly from the measurement device, as well as identifying information associated with the measurements. In an example embodiment of the method 100 using the BodyTrace™ eScale, the first server is a server dedicated to the BodyTrace™ network. A second server in the example embodiment receives body metric measurements from the first server in a manner similar to that of receiving body metric measurements from the body metric measurement devices (e.g., push or pull technology). Alternative embodiments of the method 100 may comprise storing the set of body metric measurement data on multiple servers, with additional filtering and/or receiving steps.

Storing the set of body metric measurement data S140 on a server preferably comprises filtering the received set of body metric measurement data S144, which functions to remove any suspicious measurements from the received measurement data. In particular, filtering preferably includes identifying erroneous measurements. Example erroneous measurements include measurements that are unlikely to come from a participant (e.g. measurements resulting from outsider interference), erroneous measurements due to device malfunction, erroneous measurements due to participant error, and other non-representative measurements. In one embodiment, the method 100 may further comprise detecting if an outsider has used the device (e.g. through identity verification), so as to produce an erroneous measurement. As shown in FIG. 3, identifying erroneous measurements may include analyzing for unrealistic measurement gains or losses (outliers) compared to previously determined body metric measurement trends. In a first example of filtering the received set of body metric measurement data S144, a single body metric measurement may be identified/flagged if the measurement indicates a significant weight gain of 10 pounds over one day relative to the average weight of the previous 5 days. In a second example of filtering the received set of body metric measurement data S144, any body metric measurement in the received set of body metric measurement data may be identified/flagged if the measurement deviates from an adjacent measurement by a specified amount. In a third example of filtering the received set of body metric measurement data, a line may be fitted to the set of body metric measurement data, and any measurement that has a residual (relative to the line) with an absolute value greater than a specified amount may be identified/flagged. However, any suitable analysis for filtering the received measurements may be performed. The identified/flagged measurements may be automatically removed from the data set or marked for manual review and removal from the data set. In some variations, the degree to which a flagged measurement is suspicious may affect whether the flagged measurement is automatically removed or marked for review (e.g., flagged measurements that deviate from the trend by a certain threshold amount are automatically removed from the data set).

Storing the filtered set of data on a second server S146 maintains a record of filtered measurements, such as for independent analysis (e.g. outside of the BodyTrace™ server in the example embodiment of the method 100 using the BodyTrace™ eScale). However, in an alternative embodiment, body metric measurement data may be stored in a single server, and filtering and other processing steps may be performed before or after storing the measurements on the server.

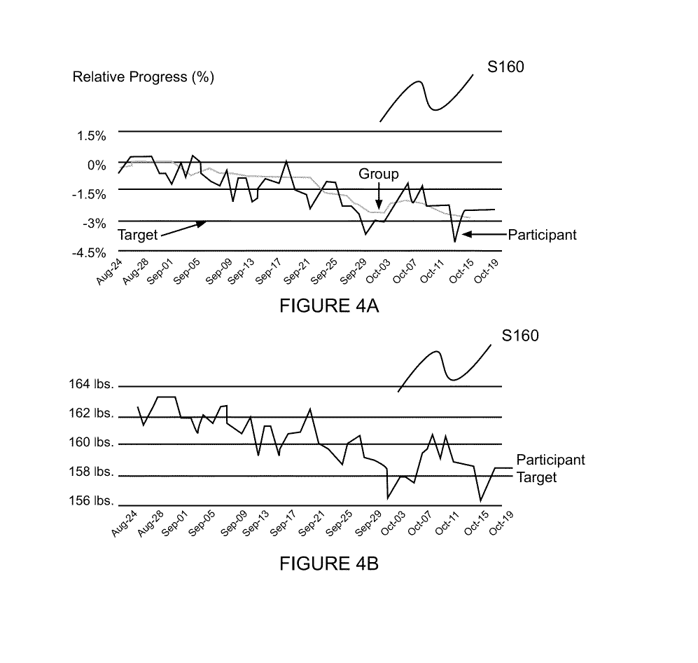

Determining a body metric measurement trend of the participant S150 functions to analyze the progress or status of the participant in the health regimen as a function of time. A determined trend is preferably subsequently stored on at least one of the servers for future use (e.g., filtering future received measurements), but alternatively, an additional server may be used to store a determined trend or a set of determined trends, each trend in the set of determined trends corresponding to a participant. Determining a body metric measurement trend of the participant S150 may include one or more of several variations: In a first variation, as shown in FIG. 4A, measurements used to determine the trend of the participant are analyzed and output as percentages relative to an initial baseline measurement. In an example of the first variation, following an initial baseline weight measurement of 200 pounds, a subsequent measurement of 195 pounds (loss of five pounds) is calculated as a data point of 2.5% loss relative to the initial baseline weight in a weight trend. Additional subsequent measurements based on the set of body metric measurement data are analyzed relative to the initial baseline weight measurement. In a second variation, as shown in FIG. 4B, measurements used to determine the trend of the participant are analyzed and output as absolute differences relative to an initial baseline measurement, similar to the first variation; however, in the second variation, measurements are expressed as absolute numbers rather than percentages. In a third variation, measurements used to determine the trend of the participant are determined as percentages relative to a previous measurement, or an averaged (e.g., mean or median) value of a certain number of previous measurements in a time series of body metric measurement data. In a fourth variation, measurements used to determine the trend of the participant are determined as absolute differences relative to one or more previous measurements, similar to the third variation; however, in the fourth variation, data points are expressed as absolute numbers rather than percentages. In a fifth variation, a line may be fitted to body metric measurements for the participant, and a rate of progress (e.g. weight loss per unit time) may be used to represent the trend of a participant.

Determining a body metric measurement trend of a portion of the matched group S152 functions to assess the progress or status of the matched group in the health regimen. Determining a trend of a portion of the matched group preferably comprises determining a trend based on a set of body metric measurement data representing all participants in the matched group or alternatively, less than all participants in the matched group. The determined trend is preferably subsequently stored on at least one of the servers for future use (e.g., filtering future received measurements), but alternatively, an additional server may be used to store a determined trend or a set of determined trends, each trend in the set of determined trends corresponding to a participant of the portion of the matched group. The trend for the portion of the matched group may be calculated in a manner similar to calculating the trend of a single participant using any suitable variation as described above, except that each measurement/data point for the portion of the matched group may be an averaged (e.g., mean or median) measurement value of all of the participants within the matched group. In a first example using averaged measurement values, a time series of body metric measurement data may be collected from each participant of the portion of the matched group, and measurements taken at similar time points (e.g. within a 24 hour period of time in a 16 week time period) may be averaged across all participants of the portion of the matched group for use in determining the trend of the matched group. In a second example using averaged measurement values, the trend of the matched group may include a different number of measurements than the number of measurements used to determine a trend in a body metric measurement of the participant S150, as measurements from the participants in the portion of the matched group may not be available for identical periods of time (e.g. measurements are received once per day from one participant and once every two days from another participant). In the second example, the trend of the matched group may include a set of measurements, each representing an average group value over a two-week period, while the trend of the participant may include a set of measurements, each measurement representing a daily value. However, both the trend of the participant and the trend of a portion of the matched group may have any suitable resolution of measurement data points. In a third example averaged measurement values, each corresponding to different time points for the portion of the matched group, may be fitted to a line, such that a rate of progress of the portion of the matched group (e.g. weight loss per unit time) may be used to represent the trend of the portion of the matched group. Preferably, the participant is a part of the portion of the matched group, such that the body metric measurement data of the participant is factored into determining the trend in the body metric measurement data of the portion of the matched group; however, alternatively, the trend in the body metric measurement of the portion of the matched group may be determined from a subset of the set of body metric measurement data, wherein the subset excludes the body metric measurement data of the participant.

Providing feedback to the participant S160 based on the trend in the body metric measurement of the participant relative to the trend in the body metric measurement of the portion of the matched group functions to use the trend in the body metric measurement of the portion of the matched group to support and motivate a participant during his or her health regimen. Preferably, the participant is a part of the matched group, such that the participant is motivated by fellow “team members” in the matched group to adhere to the health regimen. In a variation, the participant, as part of the matched group, “competes” against other matched groups as a source of support and motivation during his or her health regimen. Alternatively, the participant is not a part of the matched group, such that the participant “competes” against the matched group as a source of motivation during his or her health regimen. Preferably, feedback is provided through a user interface (described further below in more detail) communicatively coupled to at least one server that stores body metric measurements of the participants. The user interface is preferably an application accessed through a computing device, or alternatively, a website presented as a separate online social network site or online community. The user interface may alternatively be hosted by a third-party social network site. Providing feedback may include one or more of several steps as described below; however, the feedback may be provided in any suitable manner.

As shown in FIGS. 4A and 4B, providing feedback to the participant S160 preferably includes displaying the trend in the body metric measurements of the participant and/or displaying the trend in the body metric measurements of the matched group. One or both of these trends may be displayed on a profile page of the participant in a user interface. The trends are preferably displayed on charts as a function of time, with any suitable time divisions (e.g., daily, biweekly, weekly, monthly). The trends may additionally and/or alternatively be displayed as tables, bar graphs, or in any other format. In an embodiment, the method 100 follows a designated health regimen program such as the Diabetes Prevention Program, and providing feedback to the participant S160 further includes displaying individual and/or group progress in the health regimen program and metrics of any activities associated with the health regimen, such as walking (e.g. determined using a connected pedometer). Simultaneously displaying trends of a participant and of the matched group enables the participant to directly compare his or her progress and success in the health regimen with that of other participants, at least relative to the overall progress of the matched group. The overall progress of the matched group and individual progress of other participants in the matched group may be motivational to a particular participant, and are preferably relevant to a particular participant because of the nature in which the participants were sorted and grouped.

Providing feedback to the participant S160 preferably further includes enabling a facilitator associated with the matched group to access the trend of the participant and/or the trend of the portion of the matched group. Similarly, providing feedback to the participant S160 preferably further includes enabling one or more of the participants in the matched group to view a displayed trend of another participant and/or the trend of a portion of the matched group. However, providing feedback to the participant S160 may further include allowing the participant to designate privacy settings that limit the details available to other participants and/or the facilitator. For example, the participant may select settings such as to enable the facilitator and/or other participants to view a trend of his weight measurements represented in percentage of change, but to restrict the facilitator and/or other participants from viewing a trend of his/her weight measurements represented in absolute numbers.

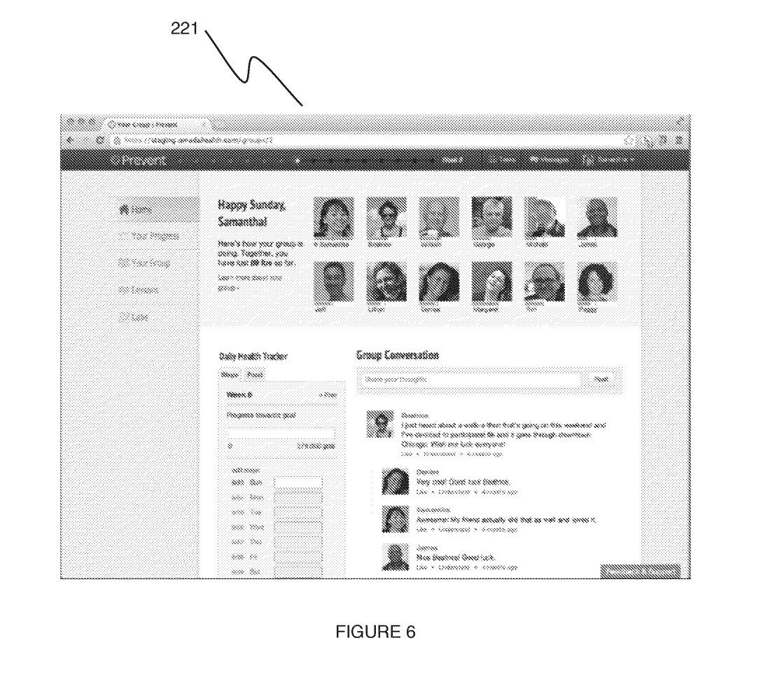

Providing feedback to the participant S160 preferably further includes enabling a facilitator associated with the matched group to provide comments to one or more of the participants in the matched group. As shown in FIG. 6, the facilitator may address general comments to the matched group on a group page of a user interface. The facilitator may additionally and/or alternatively provide targeted comments to a particular individual participant, such as by posting comments on the profile page of the participant, and/or by sending a personalized message accessible only by the individual participant and the facilitator. Similarly, providing feedback may further include enabling a participant in the matched group to provide comments to one or more of the other participants in the matched group, including general comments on the group page, targeted comments on the profile page of a particular targeted participant, and/or personalized messages accessible only by the participant and the targeted participant. Comments from the facilitator and fellow participants in the matched group serve to provide motivation and support throughout the health regimen. Such comments may include, for example, congratulatory remarks on a completed milestone, suggestions for modifications in activities (diet, exercise plan, etc.), general motivational remarks, sharing of personal stories to enhance personal connections within the matched group and/or facilitator, questions to generate discussions, invitations to perform a health regimen curriculum task socially, or any suitable comments. In some embodiments, providing feedback further includes enabling a facilitator and/or participants in the matched group to share photos or other media with another participant or the matched group in general.

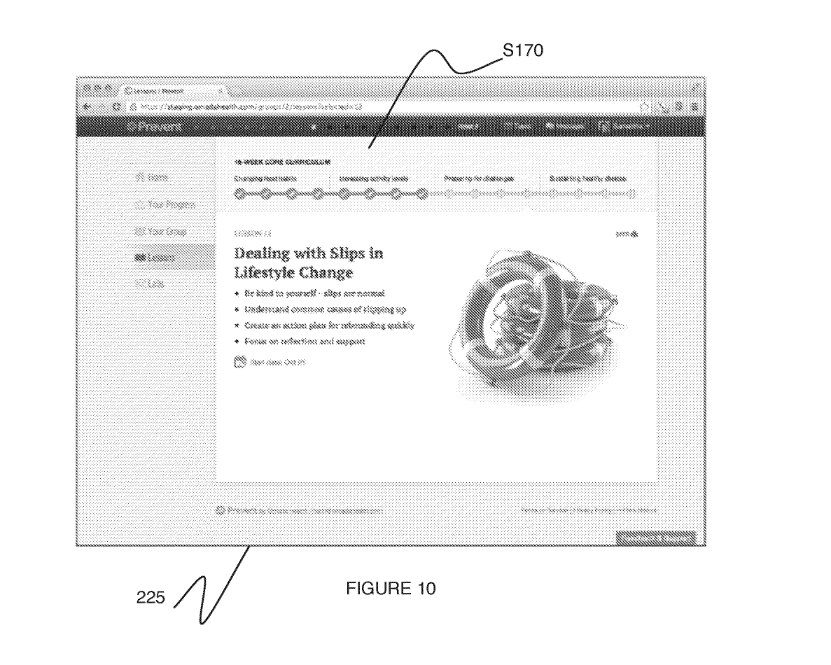

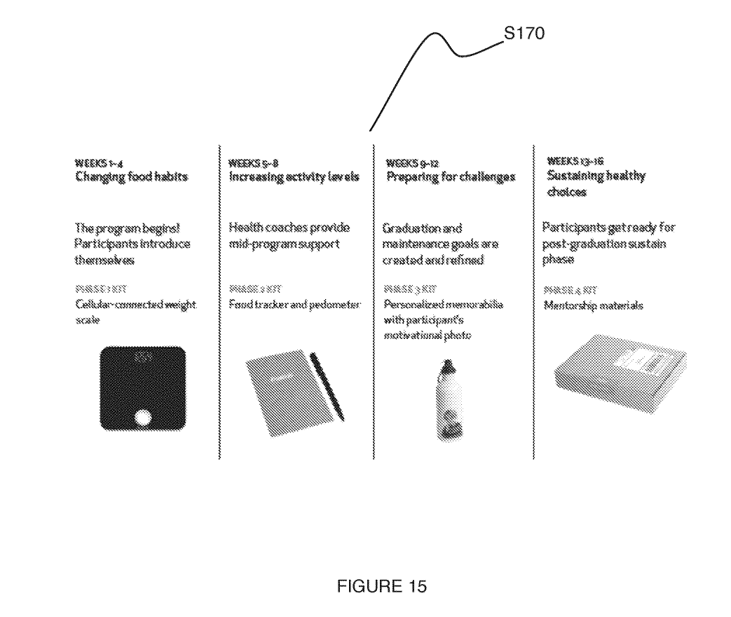

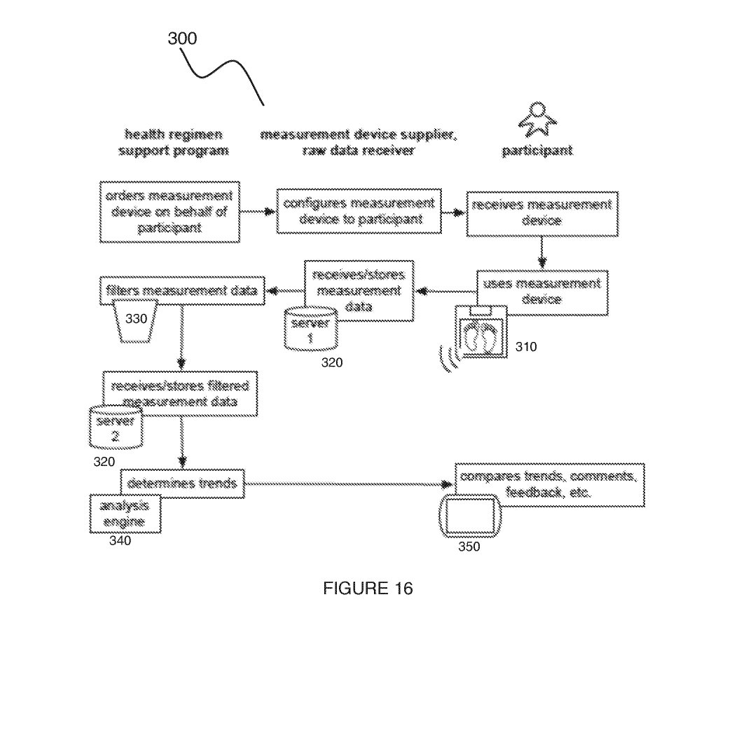

The method 100 may further include providing a health regimen curriculum S170 to each participant of the matched group, which functions to change a participant's eating and activity in order to achieve a goal. In a first example, the health regimen curriculum comprises steps outlined in the Diabetes Prevention Program (a research study funded by the National Institute of Diabetes and Digestive and Kidney Diseases), and providing a health regimen curriculum comprises presenting steps based on the Diabetes Prevention Program as lessons through a user interface. In the first example, as shown in FIGS. 10 and 15, the lessons may be organized into four phases, including: a first phase involving changing food habits, a second phase involving increasing activity levels, a third phase involving preparing for challenges, and a fourth phase involving sustaining healthy choices; furthermore, the participant may be encouraged to set goals and meet milestones, as well as complete assignments (e.g. journal entries, meal experiments) as part of the health regimen curriculum in the first example. The first example providing each of the four phases of lessons may be accompanied by providing a kit corresponding to each phase, wherein the first phase kit comprises a body metric measurement device (e.g. a network-connected weight measurement device), the second phase kit comprises a second measurement device and tool (e.g. a pedometer and a food tracking tool), the third phase kit comprises motivational prizes (i.e. upon graduating from the curriculum), and the fourth phase kit comprises materials to support the participant in sustaining healthy choices (i.e. post-graduation). In a second example, providing a health regimen curriculum S170 may comprise providing a diet modification and exercise routine regimen comprising daily meal plans and exercise tasks geared to treat a diagnosed condition, such as cardiovascular disease or diabetes. In a third example, providing a health regimen curriculum S170 may comprise providing a physical therapy regimen curriculum. In other examples, providing a health regimen curriculum S170 may comprise providing any appropriate health regimen curriculum for a given condition, that is preferably fixed, or alternatively, customizable by a participant, facilitator, or automatically to meet the participant's specific needs. The health regimen may be customizable by a facilitator or automatically, such that if the participant is not making progress at a rate comparable to that of a matched group, the health regimen may give the participant additional feedback and advice so that the participant is given an advantage or “handicap” relative to the matched group. The customized health regimen may be provided based on a performance metric of the participant, such as absolute change in body weight relative to an initial baseline measurement (after a period of time has elapsed from initiation of the regimen) or an unmet goal set by the participant and/or a facilitator.

The method 100 may further include providing a physical motivational incentive to the participant S180, which functions to promote adherence to the health regimen curriculum. Providing a physical motivational incentive to the participant S180 may comprise providing health-related physical awards, such as coupons, nutritional supplements, and/or exercise equipment. In an example, providing a physical motivational incentive to the participant S180 may be performed after the participant has reached a health regimen goal/milestone, or if the participant experiences a quantifiable level of progress above a specified threshold. In an alternative example, providing a physical motivational incentive to the participant S180 may be performed if the participant is not making progress at a rate comparable to that of a matched group, such that the participant is given an advantage or “handicap” relative to the matched group to equalize chances of success relative to the matched group. The physical motivational incentive may be provided based on a performance metric of the participant, such as absolute change in body weight relative to an initial baseline measurement (after a period of time has elapsed from initiation of the regimen) or an unmet goal set by the participant and/or a facilitator.

In some alternative embodiments of the method 100, the method 100 may omit matched groups. For example, displaying feedback may include displaying the trend of a body metric measurement of a participant on the profile page of that participant, but not displaying a trend of the body metric measurement of any other participant or group of participants. By omitting matched groups, a facilitator may be assigned to work one-on-one with a participant, instead of in a group setting.

The FIGURES illustrate the architecture, functionality and operation of possible implementations of methods according to preferred embodiments, example configurations, and variations thereof. In this regard, each block in a flowchart or block diagram may represent a module, segment, portion of code, or method step, which comprises one or more executable instructions for implementing the specified logical function(s). It should also be noted that, in some alternative implementations, the functions noted in the block can occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

User Interface for Supporting a Health Regimen

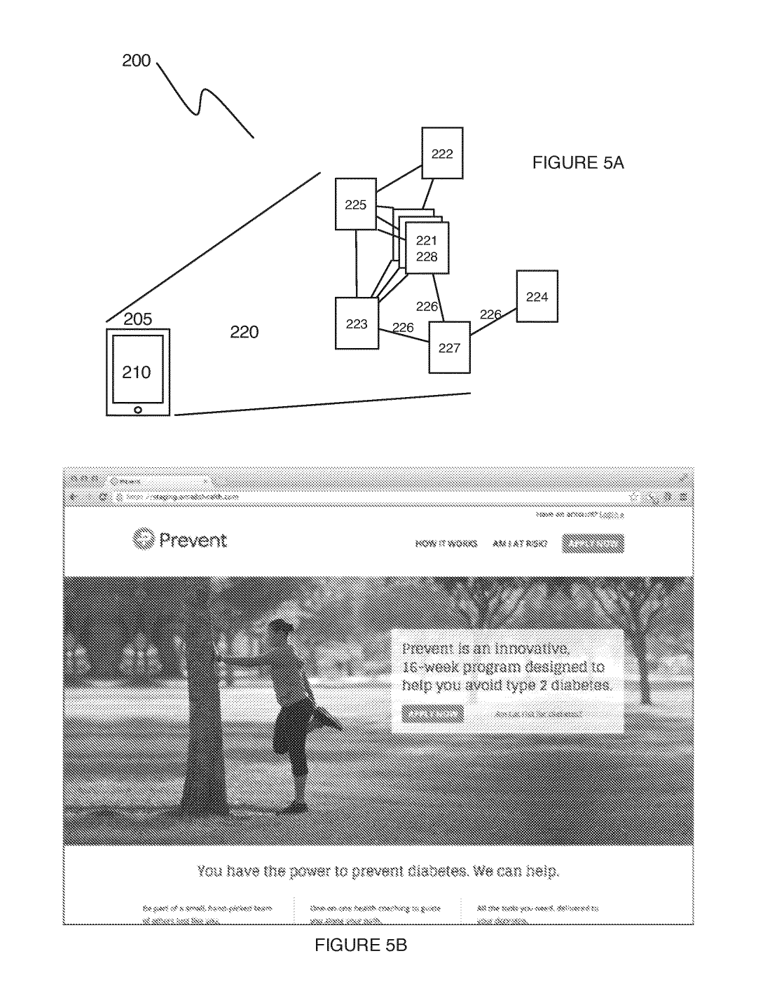

As shown in FIG. 5A, a user interface 200 for supporting a health regimen comprises a networked computing device 205 with a display 210, and an application 220 comprising a plurality of profile pages 221, each profile page corresponding to a respective participant in a first group participating in a health regimen, a progress page 222 accessible by a participant and configured to display health regimen progress of the participant, a first group page 223 corresponding to the first group ad a second group page 224 corresponding to a second group, a curriculum page 225 configured to provide a health regimen curriculum to at least the participant, a message client 226 configured to provide communication between the participant and a second entity, and at least two modes, comprising a facilitator mode 227 and a participant mode 228. The user interface 200 functions to render an interactive environment by which participants in a health regimen may receive peer-based support and facilitator-based support, as well as guidance (in the form of a health regimen curriculum) and/or personalized information regarding health regimen progress. As shown in FIG. 1, the user interface is preferably coupled to a system for supporting a health regimen.

The networked computing device 205 with a display 210 functions to process and render the application 220 for a participant. The networked computing device 205 with a display 210 is preferably a mobile device such as a smart phone, but can alternatively be a tablet, gaming device, laptop, desktop computer, television connected computing device, wearable computing device, or any suitable computing device configured to render and/or display an application. The networked computing device preferably includes an input device capable of detecting gestural input. Preferably, the input device is a touch screen, such that the display 210 also functions as a touch screen, but may alternatively be a cursor positioning device (e.g. a mouse or trackpad), a keyboard, a keypad, or any suitable input device.

The application 220 functions to provide an interface by which a participant and/or a facilitator may receive information regarding health regimen progress of a participant and/or a group of participants, and may interact with another participant in order to provide a source of motivation in support of a health regimen. In a first variation, the application 220 is centrally hosted by one or more servers, and interacts with a plurality of networked computing devices 205 with displays 210, each networked computing device 205 corresponding to a participant. In a second variation, the application 220 is hosted by a distributed system, wherein at least one networked computing device 205 with a display 210 functions as a participant terminal, as a local server, or as both. The application may be a web application accessible through a web browser on a networked computing device 205, or may alternatively be a native application on the networked computing device 205. The application 220 preferably comprises a plurality of profile pages 221, each profile page corresponding to a respective participant in a first group participating in a health regimen, a progress page 222 accessible by a participant and configured to display health regimen progress of the participant, a first group page 223 corresponding to the first group and a second group page 224 corresponding to a second group, a curriculum page 225 configured to provide a health regimen curriculum to at least the participant, a message client 226 configured to provide communication between the participant and a second entity, and at least two modes, comprising a facilitator mode 227 and a participant mode 228.

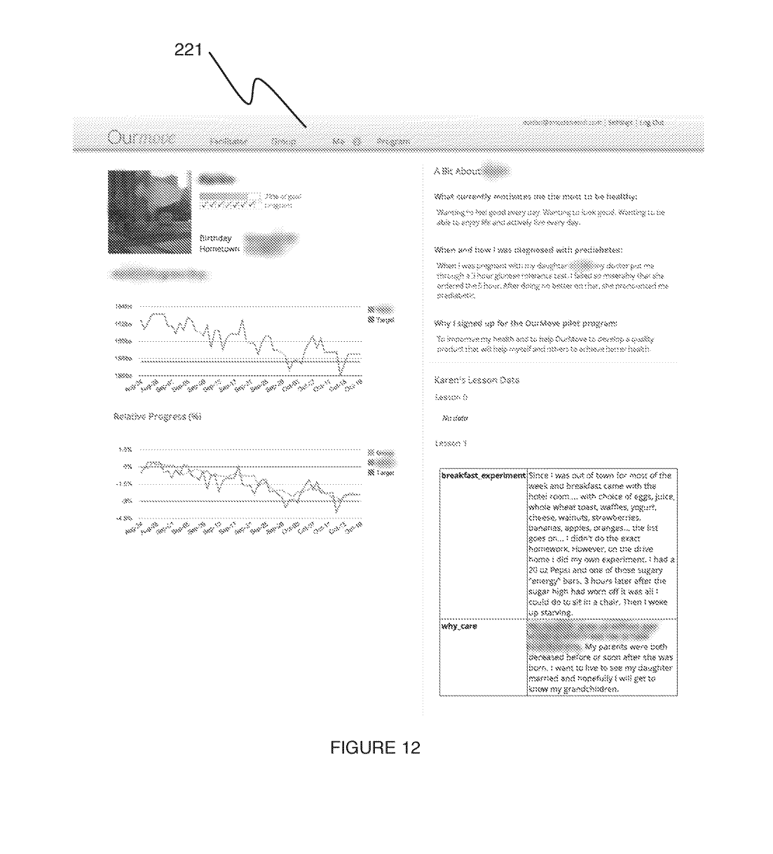

As shown in FIGS. 6 and 12, the plurality of profile pages 221 functions to display details of individual participant progress in a health regimen, as well as personal participant information. Each profile page in the plurality of profile pages 221 preferably displays annotated details of progress achieved by a given participant in the health regimen such as a trend in a body metric measurement of the participant, a trend in a body metric measurement of a participant relative to that of a matched group, and/or a target goal in the health regimen for the participant. Each profile page in the plurality of profile pages 221 may alternatively display non-annotated details of progress achieved by a given participant, or link to a progress page 222 configured to display non-annotated details of progress achieved by a given participant.

Each profile page is preferably configured to display biographical information submitted by the given participant, such as motivation for participating in the health regimen program and personalized goals. Each profile page may further be configured to display personal information such as a profile picture, name, summary of progress in the health regimen (e.g. percentage of health regimen program completed), birthday, age, geographical information, occupation, and/or any relevant personal information. Each profile page may enable the given participant corresponding to the profile page to enter additional information related to the health regimen but separate from the body metric measurements received from the measurement device, such as steps walked, meals eaten, answers to questions presented in the health regimen program, and/or any suitable information. Each profile page may also be configured to display images and/or links to profile pages corresponding to other participants in a matched group that comprises the given participant. Additionally, each profile page may comprise a messaging center configured to display messages between the given participant and a facilitator, and/or messages between the given participants and at least one participant of a matched group.

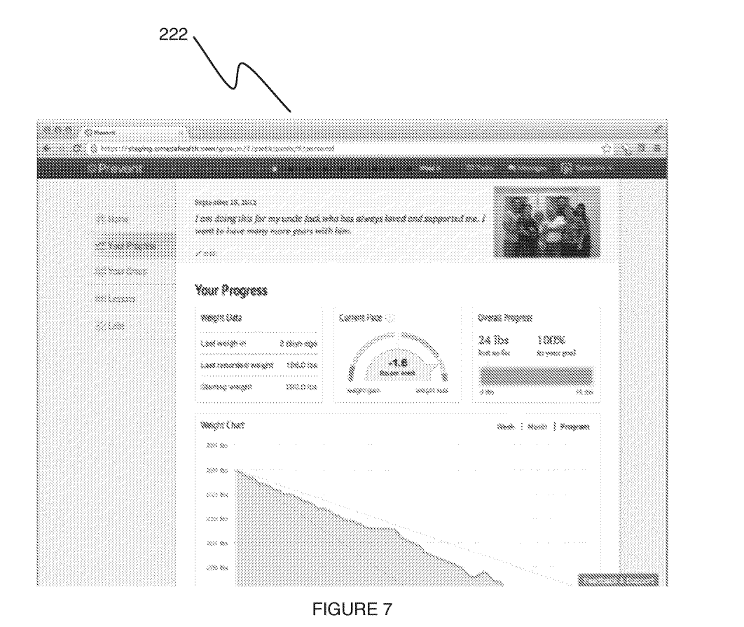

As shown in FIG. 7, the application 220 also comprises a progress page 222 accessible by a participant and configured to display health regimen progress of the participant. The progress page 222 functions to display participant progress in the form of visuals and/or analyzed metrics as a source of motivation for a participant following a health regimen. The progress page 222 is preferably configured to display details and analyses of progress achieved by a given participant in the health regimen such as a trend in a body metric measurement of the participant, a trend in a body metric measurement of a participant relative to that of a matched group, and/or a target goal in the health regimen for the participant. The progress page 222 may be further configured to display overall progress achieved by a participant relative to certain earlier points and/or a starting point, a rate of progress (e.g. body metric change versus time), overall progress achieved by a participant relative to a goal, and/or other personalized biometric data (e.g. current weight, height, age, body mass index). Preferably, the progress page 222 is distinct from a profile page for a participant; however, alternatively, the progress page 222 and profile page for a participant are non-distinct pages.

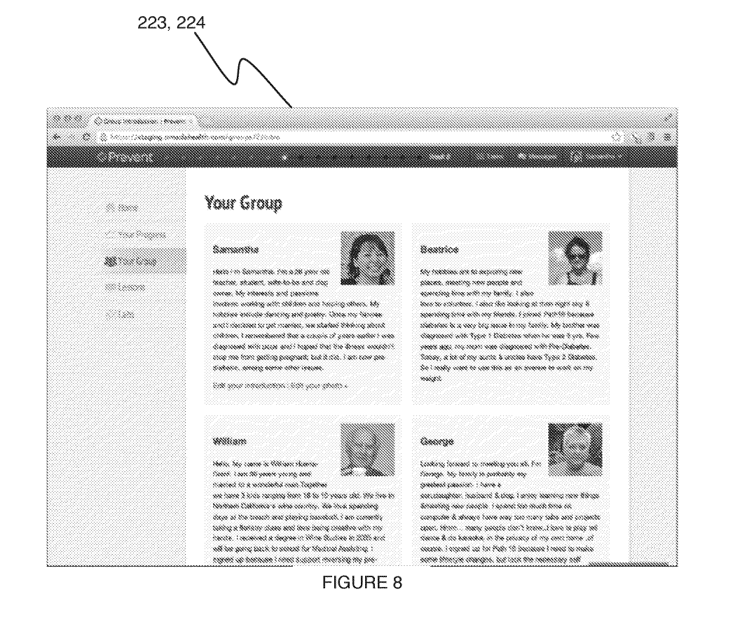

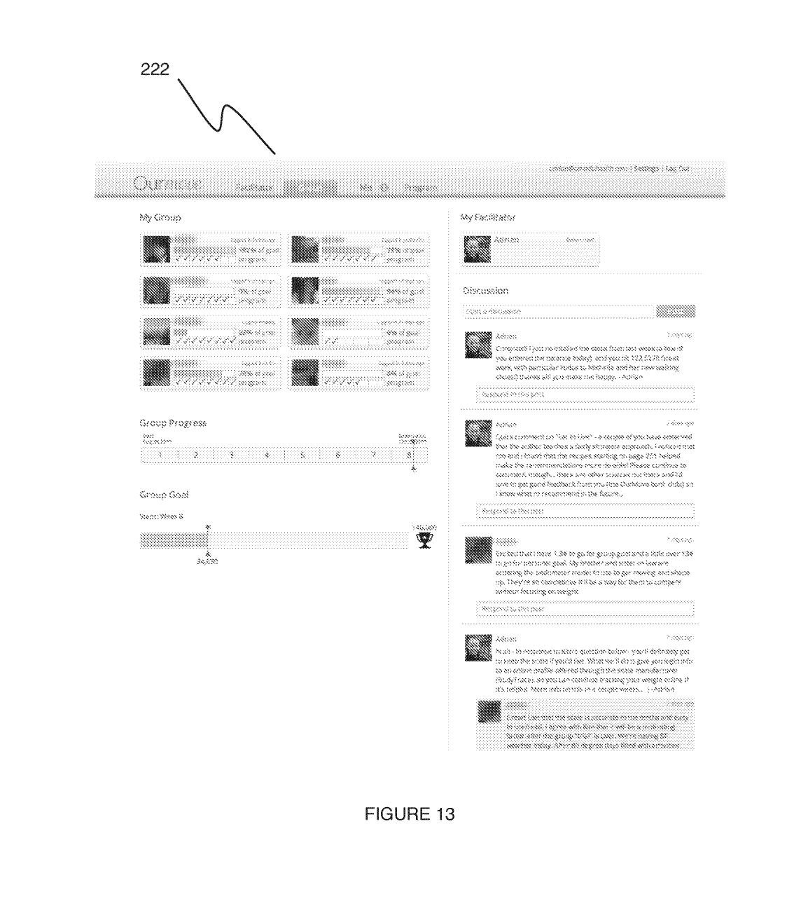

The application 220 also comprises a first group page 223 and a second group page 224 that each function to provide a centralized hub for interactions between participants of a group participating in a health regimen. As shown in FIGS. 8 and 13, a group page 223, 224 preferably displays a list and/or thumbnail summaries of the participants in a group participating in a health regimen, summary information about the progress of the group in the health regimen (e.g. trends and metrics determined from body metric measurement data), and any feedback addressed to the overall group from a facilitator and/or other participants. A group page 223, 224 preferably also comprises links to profile pages of all participants of the group, and may further comprise information regarding the health regimen being followed by participants in the group. In alternative embodiments, a group page 223, 224 may only display a list and/or thumbnail summaries of the participants in a group participating in a health regimen, and links profile pages corresponding to each member III the group participating in a health regimen, as shown in the example of FIG. 8.

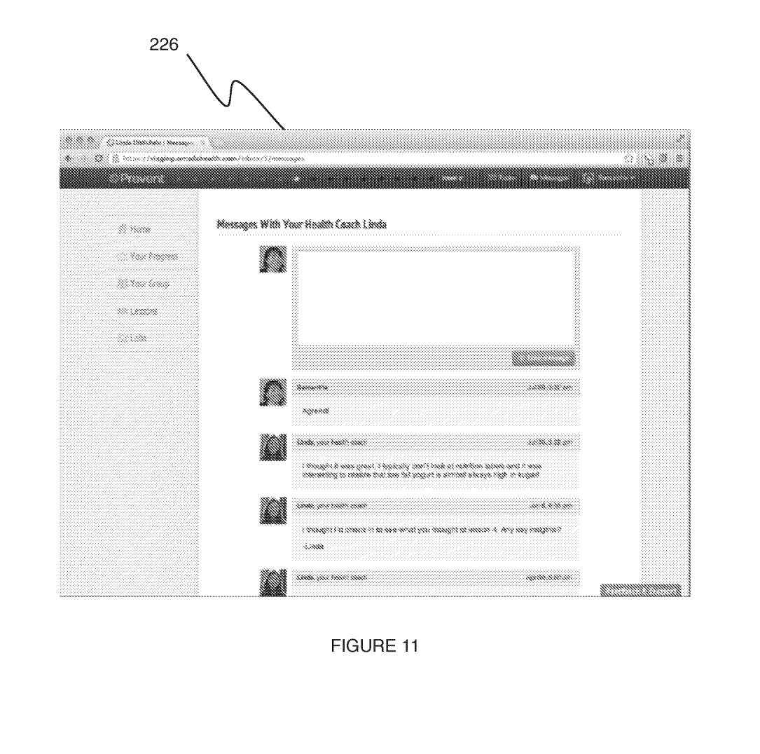

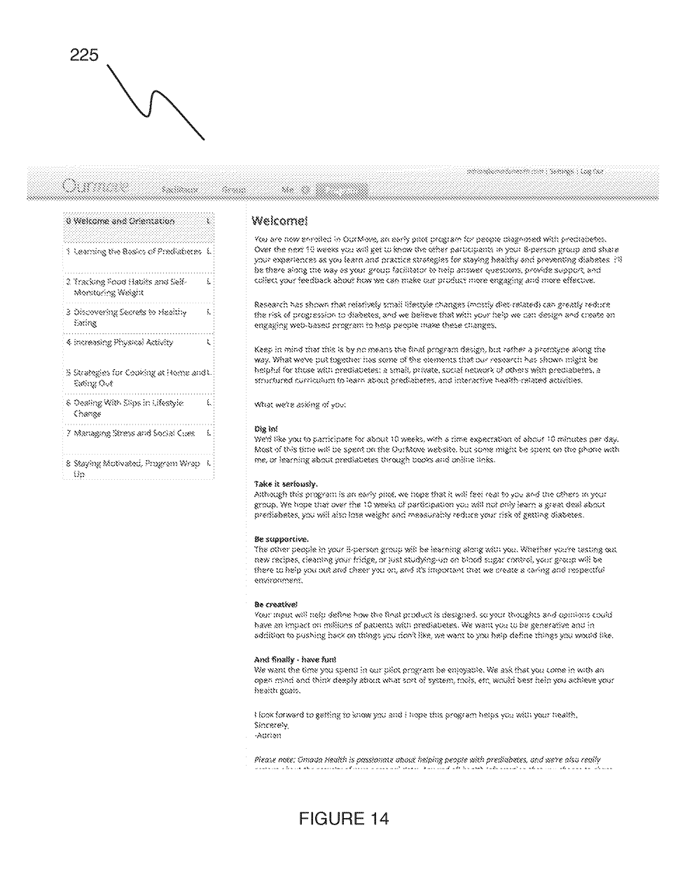

The application 220 also comprises a curriculum page 225 that functions to provide a health regimen curriculum intended to be followed by a participant. The curriculum page 225 preferably outlines steps or other features of a health regimen program. In the preferred embodiment, the curriculum page outlines steps based on the Diabetes Prevention Program (a research study funded by the National Institute of Diabetes and Digestive and Kidney Diseases), but in alternative embodiments, the curriculum page outlines steps or teaches lessons from other alternative health regimens. In an example, as shown in FIG. 14, the curriculum page 225 may include a welcome introduction to the program, tips, guidelines, and/or instructions corresponding to the health regimen program. In another example, as shown in FIG. 11, the curriculum page 225 may alternatively display health regimen tips in the form of a lesson plan, comprising modules, milestones, and/or assignments. Preferably, the curriculum page is configured to display the same curriculum for all participants in a group participating in a health regimen; however, alternatively, the curriculum page may be configured to display a curriculum that is customized to a given participant (e.g. based on participant performance). Preferably, the curriculum page 225 is accessible from a profile page 221, a progress page 222, and a group page 223, 224, but alternatively, the curriculum page 225 is accessible from a subset of a profile page 221, a progress page 222, and a group page 223, 224.

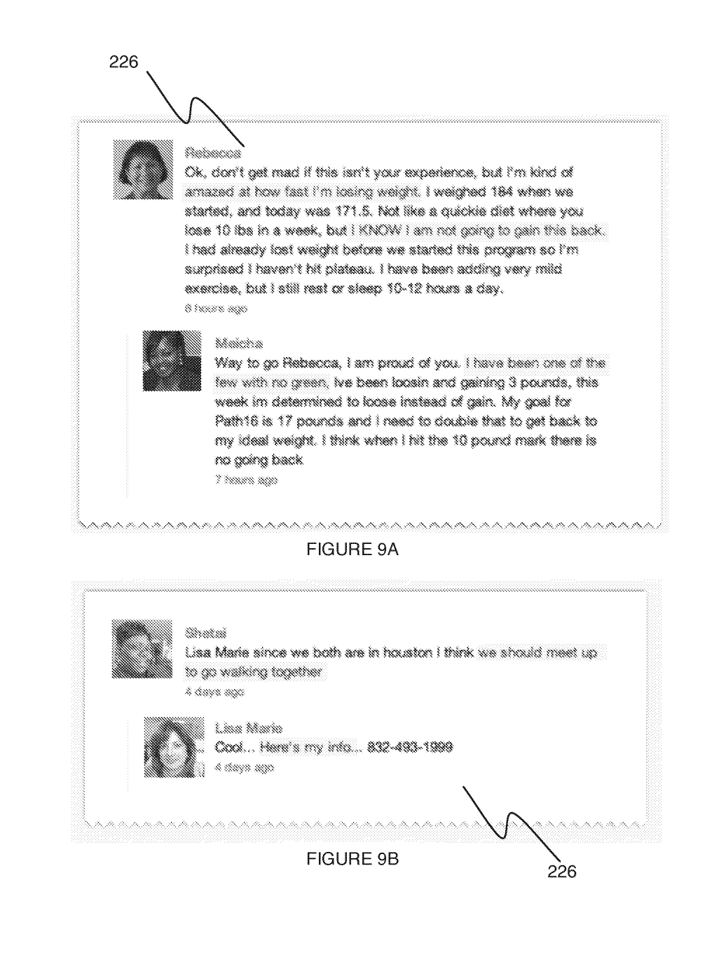

The application 220 also comprises a message client 226 that functions to enable communication between a participant and another entity, facilitated by the user interface. The message client preferably communicates with a server of a message service provider, server of a mailbox service that is a proxy for the message service provider, or any suitable messaging service. The message client preferably enables sending and receiving of messages, and may incorporate messages into a rendered interface. As shown in FIGS. 9A and 9B, the message client 226 may enable communication between a first participant and a second participant. In the example shown in FIG. 9A, a second participant may provide verbal motivational support to a first participant by describing a personal experience while following the health regimen. In the example shown in FIG. 9B, a first participant may connect with a second participant and set up a meeting to perform a task associated with a health regimen curriculum together. Additionally, the message client 226 may enable communication between a participant and a facilitator. In the example shown in FIG. 11, the facilitator may provide advice and motivational support to a participant through the message client 226, in a manner that is only accessible by the participant and the facilitator (i.e. no other participants have access to a communication between the participant and the facilitator). Preferably, either a participant or a facilitator may initiate a participant-facilitator communication by using the message client 226; however, alternatively, only the facilitator may initiate a participant-facilitator communication using the message client 226. The message client preferably also enables communication between more than two entities (e.g. a participant may communicate with at least two other participants, or at least one other participant and a facilitator).

The user interface preferably comprises at least two modes, including a facilitator mode 227 that is activated by a facilitator, and a participant mode 228 that is activated by a participant. The facilitator mode 227 and the participant mode 228 function to provide a facilitator view of the user interface and a participant view of the user interface that is preferably generally more restricted than the facilitator view (except, for example, a particular participant may have an unrestricted view of his or her own profile page), respectively. The facilitator and/or participant modes 227, 228 enable levels of privacy and/or access to respective profile pages of participants. In one example, in the facilitator mode 227 a facilitator of a group may have permission to view a trend in a body metric measurement represented both in percentage change and in absolute numbers, while in a participant mode 228 other participants of the group may be restricted to view only the trend in a body metric measurement represented in percentage change. In a second example, in the facilitator mode 227 a facilitator of a group may have access to all personal and/or biographic information corresponding to each participant in the group he or she facilitates, whereas in participant mode 228 a participant may only have access to his or her own personal and/or biographic information. Such restrictions are preferably set by the participant in a settings portal, as will be understood by one ordinarily skilled in the art. However, the user interface preferably enables each participant to set any suitable privacy and access settings to his profile page or other personal information.

In one embodiment, the facilitator mode 227 may further enable a facilitator to facilitate more than one group (e.g. the first and second group). The facilitator mode may thus comprise an additional facilitator page that enables the facilitator, using the message client 226, to communicate with all groups that the facilitator facilitates. The facilitator mode may enable the facilitator to communicate individually with members of the groups he/she facilitates, or to communicate with an entire group or portion of a group he/she facilitates. In a variation, the facilitator mode 227 may further enable a facilitator to have unrestricted viewing access to all profile pages and group pages corresponding to groups he/she facilitates, but may restrict the facilitator from modifying information displayed on the profile and group pages. In another variation, the facilitator mode 227 may enable a facilitator to have unrestricted viewing access to and the ability to modify all profile pages and group pages corresponding to groups he/she facilitates.

In other embodiments of the user interface 200, the first and second group pages 223, 224 may be further configured to provide a competition between the first group and the second group, in achieving a health regimen goal. In a first variation, a participant of the first group may compete with a portion of the participants of the second group, by accessing at least one of the first and second group pages 223, 224. In a second variation, the entire first group may compete with the entire second group, using at least one of the first and second group pages. Other embodiments of the user interface may incorporate additional pages, such as a home page, as shown in FIG. 5B, and/or functionality in the facilitator and participant modes 227, 228 to further support the health regimen.

System for Supporting a Health Regimen

A system 300 for supporting a health regimen comprises one or more body metric measurement devices 310 each corresponding to a participant, and configured to transmit a set of body metric measurement data; at least one server 320 configured to receive and store a set of body metric measurement data from the body metric measurement devices; a processor 330 configured to filter the set of body metric measurement data, thus producing a filtered set of body metric measurement data; an analysis engine 340 configured to analyze the filtered set of body metric measurement data and determine a trend in the filtered set of body metric measurement data; and a user interface 350 configured to provide health regimen progress information, a health regimen curriculum, and communication between the participant and a second participant. The system 300 may further comprise The system 300 preferably performs the steps as described in the method for supporting a health regimen and is supported by the user interface 200, which preferably helps foster a supportive community environment that motivates, inspires, and otherwise supports participants as they participate in the health regimen.

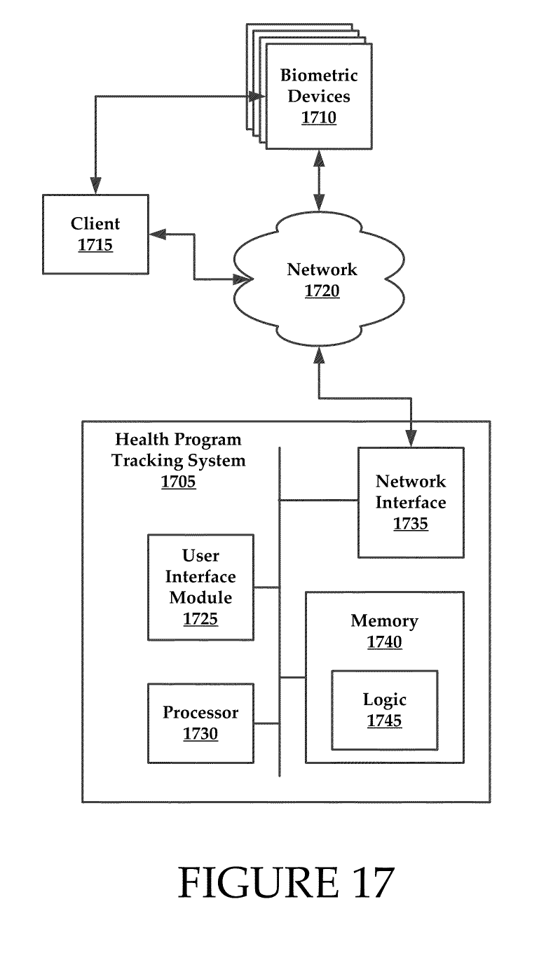

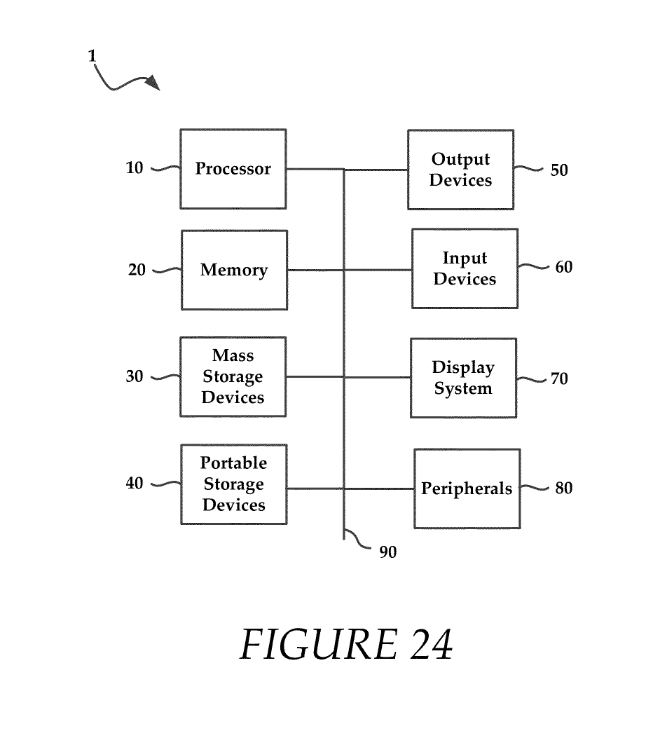

FIG. 17 illustrates an exemplary architecture for practicing aspects of the present technology. The architecture comprises a health program tracking system, hereinafter “system 1705” that is configured to track the performance of participants in a group program (e.g., a health regimen). Generally the system 1705 is configured to communicate with client devices, such as client 1715. The client 1715 may include, for example, a Smartphone, a laptop, a computer, or other similar computing device. An example of a computing device that can be utilized in accordance with the present invention is described in greater detail with respect to FIG. 24.

The system 1705 may communicatively couple with the client 1715 and biometric devices 1710 via a public or private network 1720. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 1720 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

Suitable biometric devices include, but are not limited to, pedometers, scales, blood sugar monitors, blood pressure monitors, electrocardiograms (ECG), thermometers, heart rate monitors, and other medical or diagnostic devices that are configured to monitor or determine a wide variety of biometrics/biomarkers of an individual.

The system 1705 generally comprises a user interface module 1725, a processor, 1730, a network interface 1735, and a memory 1740. According to some embodiments, the memory 1740 comprises logic 1745 that can be executed by the processor 1730 to perform operations and methods such as the administration of a health improvement program in conjunction with an adjunct medical treatment. The system 1705 may administer the program and the adjunct medical treatment for an individual who is in need of improving one or more medical conditions, such as obesity, pre-diabetes, diabetes, and so forth. The administration of the program and the adjunct medical treatment by the system 1705 may occur in such a way that when an individual cannot successfully accomplish an improvement in a desired medical condition using the health improvement program alone, the system 1705 may flag the individual as being a candidate for an interventive adjunct medical treatment such as a surgery, a drug, a medicament, or other complementary medical treatment/procedure. As will be appreciated by one of ordinary skill in the art, the adjunct medical treatment required for the individual may vary according to the health condition, a magnitude of failure with respect to the health improvement program, frequency of recidivism with respect to the health improvement program, and other factors, which will be described in greater detail below.

By way of example, a health condition may include obesity, pre-diabetes, heart disease, pre-hypertension, hypertension, pre-coronary atherosclerosis, and pre-renal failure, combinations thereof, and/or other health conditions that would be known to one of ordinary skill in the art.

Generally, a group program is a health improvement program that is tailored to the needs of the group. Examples of health improvement programs include, but are not limited to weight loss programs, diet programs, cardiovascular training, mental health programs, strength and conditioning programs, or other health improving endeavors. The health improvement program may include combinations of various programs.

As mentioned above, an adjunct medical treatment may include a surgery or medical procedure. For example, if the health condition is pre-diabetes and the participant needs to lose a specified amount of weight, also if the participant fails to achieve a weight loss goal using the health improvement program (e.g., workout and diet plan), the adjunct medical treatment may include administration of a drug such as Metformin, or the referral of the participant for a surgery such as gastric bypass. The adjunct medical treatment may also comprise any of a therapeutic drug, a diet, a medical device, a surgery, and any combinations thereof.

Provided below are various embodiments of methods that are executed by the system 1705 to accomplish various goals such as managing a health condition and/or improving a health condition.

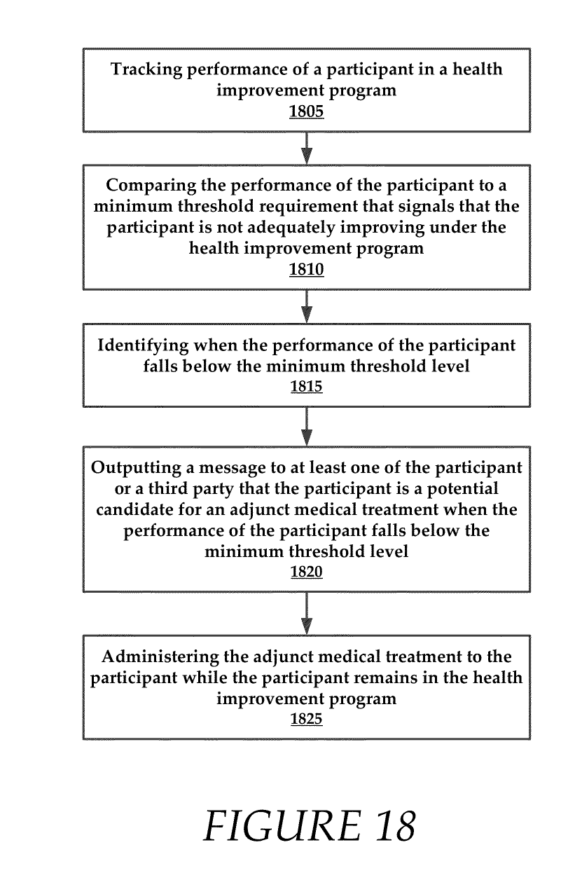

FIG. 18 is a flowchart of a method for managing a health condition by using a health program server, such as system 1705. The method may comprise tracking 1805 by the system 1705 performance of a participant in a health improvement program. Again, the health improvement program is designed to improve the health condition of the participant, which may include any of the health conditions listed above or known to one of ordinary skill in the art. Tracking of the performance of the participant may include receiving feedback from the participant using a health improvement application that is executed on a mobile device utilized by the participant, or a web-based application that may be facilitated by the system 1705. For example, the participant may input metrics such as food consumption, exercise, sleep habits, or other health program participation data, which may include input required by the specific health improvement program. By way of example, if the health improvement program includes a weight loss program, data input by the participant may include caloric intake, exercise, and so forth. Also, data may be received by the system 1705 from a biometric device, such as a pedometer, a scale, a blood-sugar meter, and the like.

With regard to biometric markers, the system 1705 may receive or calculate biometric data about the participant. The biometric data may include, for example, blood sugar values, heart beat values, blood pressure, temperature, weight, body mass index values, body fat percentage, hydration, and other biometric data.

In some instances, the method includes comparing 1810 by the system 1705 the performance of the participant to a minimum threshold requirement that signals that the participant is not adequately improving under the health improvement program. Thus, in some embodiments, the system 1705 may include minimum thresholds that are linked to the health improvement program. These minimum thresholds may include, for example, with respect to a weight loss program, an ideal weight value for the participant. Alternatively, the minimum threshold may include a target weight value for the participant. For example, the participant may have a weight loss goal for a month of at least five pounds. Thus, the minimum threshold would be calculated by subtracting an initial weight value for the participant from the desired weight loss value to establish the minimum threshold.

Other exemplary minimum thresholds may include, but are not limited to, a desired A1C (Glycated Hemoglobin) number, a blood pressure number, a body fat percentage value, a hydration number, or any other measurable biomarker that can be measured in qualitative and/or quantitative terms.

The method may also include identifying 1815 by the system 1705 when the performance of the participant falls below the minimum threshold level. In some instances, this may include comparing by the system 1705 a current value to the expected or minimum threshold value(s) established within the system 1705. For example, the system 1705 may compare a current weight value for the participant to an expected or minimum threshold value that was established for the participant. The participant may have a weight of 245 pounds and the expected or minimum threshold value established for the participant is 242 pounds. Based upon a determination that the participant has failed to meet the minimum threshold value, the system 1705 may proceed to output one or more messages as described below.

It is noteworthy to mention that empirical values for weight, body fat, biometric values, and other measurable quantities relating to the health of the participant may be input into the system 1705 by using the mobile application or the web-based application as described above. Alternatively, these measurable quantities may be transmitted to the system using, for example, one of any of a number of biometric devices that may be used by the participant. For example, a smart scale may transmit weight, body fat percentage, hydration, and other values to the system 1705 periodically. Other biomarker values such as A1C may be transmitted to the system 1705 via a physician or personal biomedical device such as a blood sugar meter that is configured to couple with the system 1705 over a network.

It will be understood that the system 1705 may not only compare a current value to the minimum threshold value for the participant and output a message to a medical professional or other third party, but the system 1705 may also be configured to determine a magnitude of discrepancy between the actual values and the minimum threshold value and determine a course of action based upon this magnitude. For example, the participant may miss their weight loss goal by 25% or may miss their target weight loss goal by 80%. Alternatively, the participant may have actually gained weight. The system 1705 may determine an urgency with which an intervention for the participant is needed based upon the magnitude of discrepancy. The participant that misses their weight loss goal by 25% is not in as much danger of failure or recidivism as the participant that misses their weight loss goal by 80%, or actually gains weight.

Notwithstanding, the method may include outputting 1820 by the system 1705 a message to at least one of the participant or a third party that the participant is a potential candidate for an adjunct medical treatment when the performance of the participant falls below the minimum threshold level. Again, the details of this message may be affected at least due to the magnitude of discrepancy between the actual values and the minimum threshold value. In other instances, a message may be transmitted when any discrepancy between the actual values and the minimum threshold value is calculated by the system 1705.

According to some embodiments, the method may include administering 1825 the adjunct medical treatment to the participant while the participant remains in the health improvement program. For example, a physician may administer an anti-diabetic drug such as Metformin to the participant. Another physician or health professional may prescribe a weight loss supplement or consult with the participant about a weight loss surgery. Again, the specifics of the adjunct medical treatment may be defined by the health condition and/or the desired goal.

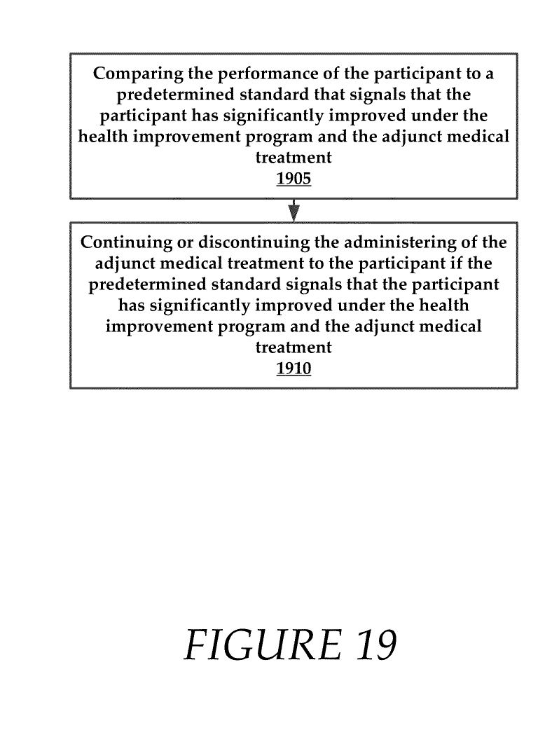

FIG. 19 is a flowchart of a sub-method of the method of FIG. 18. FIG. 19 illustrates a step of comparing 1905 by the system 1705 the performance of the participant to a predetermined standard that signals that the participant has significantly improved under the health improvement program and the adjunct medical treatment. For example, when the system 1705 may determine that the participant has met reduced a specific biomarker or set of biomarkers to within an acceptable range when the health improvement program has been combined with an anti-diabetes drug. For example, the system 1705 may determine that an A1C level for the participant is within an acceptable range when both the health improvement program and the adjunct medical treatment (e.g., use of Metformin) have been used for sixty days. Thus, the predetermined standard in this instance would be an acceptable range of A1C levels.

Next, the method may include continuing or discontinuing 1910 the administering of the adjunct medical treatment to the participant if the predetermined standard signals that the participant has significantly improved under the health improvement program and the adjunct medical treatment. That is, the system 1705 is configured to determine, by comparison of the predetermine standard to actual values of the participant, if the adjunct medical treatment should be continued or not. For example, the system 1705 may determine that the participant's A1C level is not yet within the acceptable standard range. Thus, the system 1705 may output a message to the physician that the participant should continue on the combination of the health program and the adjunct medical treatment. Conversely, if the specified biomarker is within the predetermined standard range, the system 1705 may indicate to the physician that the adjunct medical treatment may be suspended or a dosage modified.

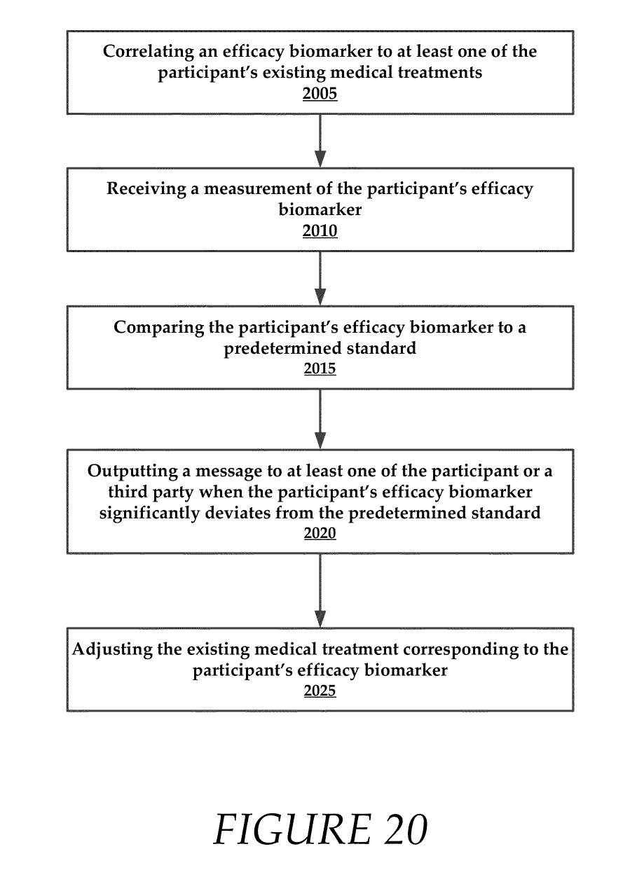

FIG. 20 includes a flowchart of a method of the present technology that specifically relates to the use and measurement of an efficiency biomarker. An efficiency biomarker may include a metric that is directly or indirectly indicative of the efficiency with which the adjunct medical treatment has a measurable effect on a particular biomarker. For example, the efficiency biomarker may be indicative of how effective the addition of an anti-diabetes drug is on reducing certain biomarkers that are associated with a diabetic condition, such as A1C, fasting plasma glucose (FPG), fasting serum insulin, adiponectin, C-reactive protein (CRP), ferritin, interleukin-2 receptor A (IL2RA), and combinations thereof—just to name a few.

In some instances, the method includes correlating 2005 an efficacy biomarker to at least one of the participant's existing medical treatments. For example, the system 1705 may correlate an efficiency biomarker such as A1C with a medical plan for the participant, such as a diabetic intervention program.

In some embodiments the method includes receiving 2010 a measurement of the participant's efficacy biomarker. Again, this may occur via feedback from a biometric device, an electronic medical record, or input from the participant or a third party into the system 1705. The method may also include comparing 2015 the participant's efficacy biomarker to a predetermined standard. When the participant's efficacy biomarker significantly deviates from the predetermined standard the method may include outputting 2020 a message to at least one of the participant or a third party when the participant's efficacy biomarker significantly deviates from the predetermined standard.

If desired, the method may include adjusting 2025 the existing medical treatment corresponding to the participant's efficacy biomarker. This adjustment may include, for example, increasing or decreasing a dosage for a therapeutic drug.

Optionally, the system 1705 may be configured to provide questions to the participant that are designed to elicit responses regarding whether the participant is experiencing adverse effects from the adjunct medical treatment. In some instances these questions are related to expected side-effects for the adjunct medical treatment provided to the participant. In other instances, participants may provide to the system 1705 feedback regarding any actual or perceived side effects. In other embodiments, the system 1705 may provide questions to the participant that are designed to elicit responses regarding the participant's existing medical treatments.

According to some embodiments, the system 1705 may be configured to provide questions to the participant that are designed to elicit responses regarding whether the participant is experiencing adverse effects from the existing medical treatments.

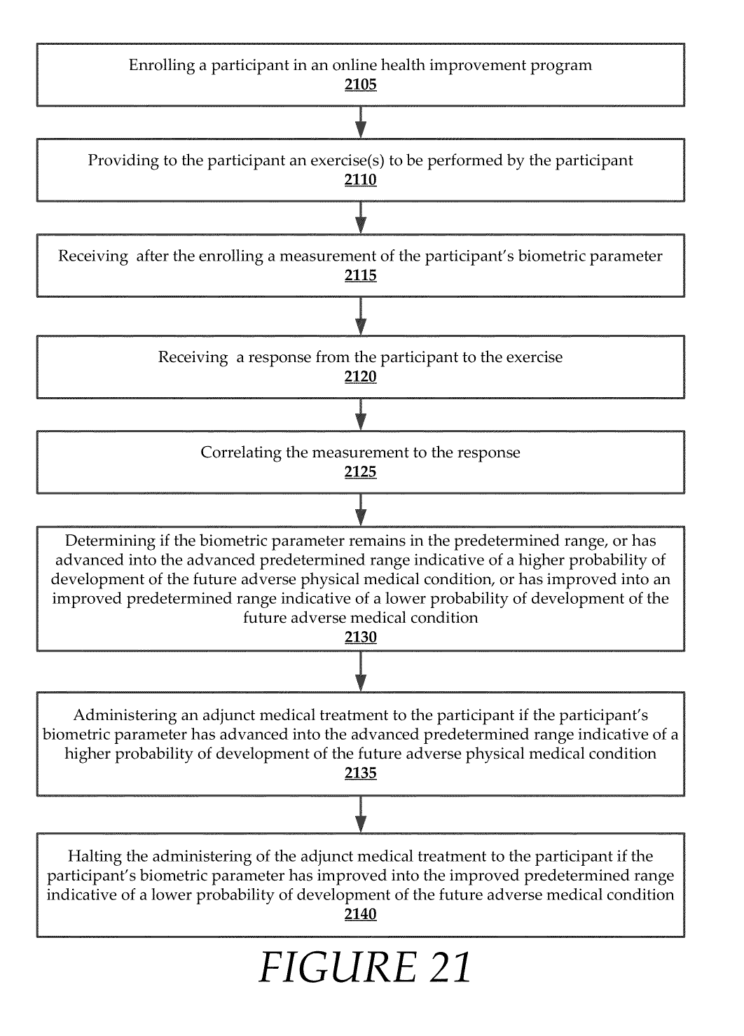

FIG. 21 is a flowchart of another exemplary method for improving a health condition by using a health program server (e.g., system 1705). The method may include enrolling 2105 a participant in an online health improvement program managed by the system 1705.

It will be understood that the participant preferably has a biometric parameter in a predetermined range indicative of a future adverse physical medical condition if the biometric parameter remains in the predetermined range or advances into an advanced predetermined range indicative of a higher probability of development of the future adverse physical medical condition. For example, the biometric parameter may include Interleukin-18 that is indicative of a higher probability of the participant developing atherosclerosis. Specifically, relatively high levels of IL-18 may be indicative of future or current atherosclerosis.

Next, the method includes providing 2110 to the participant an exercise to be performed by the participant. In some instances the exercise is designed to improve the biometric parameter if performed by the participant on a frequency designated by the online health improvement program. An example may include a weight lifting regimen.

The method also includes receiving 2115 by the system 1705 a measurement of the participant's biometric parameter. Again, this may occur via transmission from a biometric device to the system 1705 or by receipt of an electronic medical record by the system 1705, just as examples. The method also includes receiving 2120 a response from the participant to the exercise as well as correlating 2125 the measurement to the response. Next, the method includes the system 1705 determining 2130 if the biometric parameter remains in the predetermined range, or has advanced into the advanced predetermined range indicative of a higher probability of development of the future adverse physical medical condition, or has improved into an improved predetermined range indicative of a lower probability of development of the future adverse medical condition.

According to some embodiments, the method includes administering 2135 an adjunct medical treatment to the participant if the participant's biometric parameter has advanced into the advanced predetermined range indicative of a higher probability of development of the future adverse physical medical condition.

In some instances, the method includes halting 2140 the administering of the adjunct medical treatment to the participant if the participant's biometric parameter has improved into the improved predetermined range indicative of a lower probability of development of the future adverse medical condition.

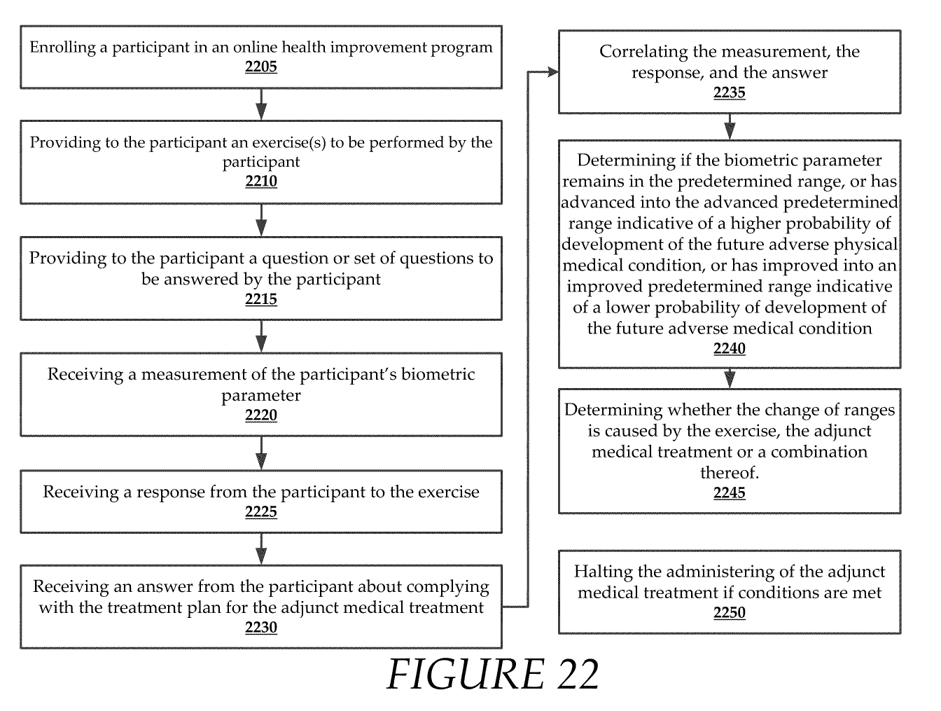

FIG. 22 is a flowchart of another method for improving a health condition using a combination of a health improvement program and adjunct medical treatment. The method of FIG. 22 includes a step of enrolling 2205 a participant in an online health improvement program managed by the health improvement program server. The participant has a biometric parameter that is within in a predetermined range indicative of a future adverse physical medical condition if the biometric parameter remains in the predetermined range or advances into an advanced predetermined range indicative of a higher probability of development of the future adverse physical medical condition. Further, the participant receives an adjunct medical treatment designed to improve the biometric parameter if used by the participant per a treatment plan.

Next, the method includes providing 2210 to the participant an exercise to be performed by the participant. In some embodiments the exercise is designed to improve the biometric parameter if performed by the participant on a frequency designated by the online health improvement program. In some instances, the exercise includes a plurality of exercises that may be administered by a coach or personal trainer, for example.

In some instances, the method includes providing 2215 to the participant a question or set of questions to be answered by the participant. The question(s) are designed to determine if the participant is complying with the treatment plan for the adjunct medical treatment. The method includes receiving 2220 a measurement of the participant's biometric parameter. For example, the biometric parameter may include a maximal oxygen uptake (VO2max) for the participant, which is representative of the aerobic physical fitness level of the participant. An increase in VO2max is correlated with an improved physical condition and may be indirectly indicative in an improvement in the overall physical condition of the participant. An increase in physical condition may be further correlated with a loss of weight and improvement in biometric markers for diabetes, pre-diabetes, and so forth.

Next, the method includes receiving 2225 a response from the participant to the exercise. Again, this may be received from a device such as a treadmill or other medical device that measures the actual exercise values, from reporting by the participant or the health program administrator, or from another third party.

In accordance with the present disclosure, the method may include receiving 2230 an answer from the participant about complying with the treatment plan for the adjunct medical treatment, as well as a step of correlating 2235 by the system 1705 the measurement, the response, and the answer. The method may further include the system 1705 determining 2240 if the biometric parameter remains in the predetermined range, or has advanced into the advanced predetermined range indicative of a higher probability of development of the future adverse physical medical condition, or has improved into an improved predetermined range indicative of a lower probability of development of the future adverse medical condition.

If the system 1705 determines that the biometric parameter has changed ranges, the method further comprises determining 2245 whether the change of ranges is caused by the exercise, the adjunct medical treatment or a combination thereof. If the system 1705 determines that the change of ranges is a change to the improved predetermined range indicative of a lower probability of development of the future adverse medical condition, and the change is caused by the exercise, the method may include a step of the system 1705 halting 2250 the administering of the adjunct medical treatment. This step may include the system 1705 outputting a message to the individual administering the adjunct medical treatment that the treatment should be halted.

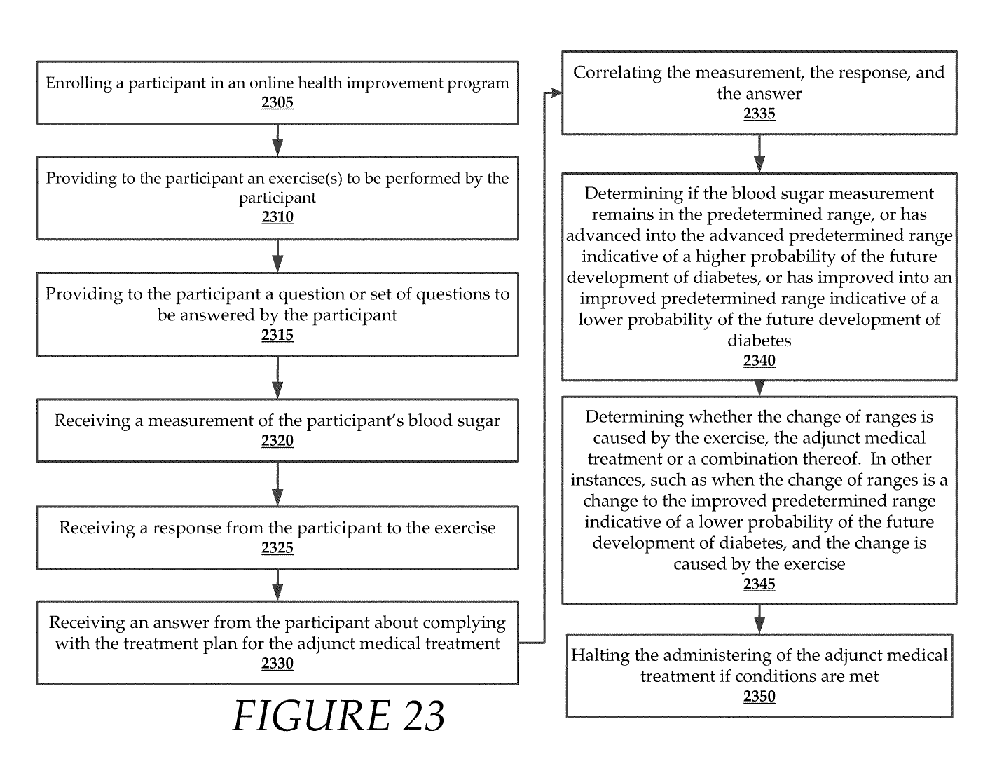

In one embodiment of the present technology, the system 1705 may execute a method for slowing down or reversing an onset of diabetes. FIG. 23 is a flowchart of a method that includes enrolling 2305 a participant in an online health improvement program managed by the health improvement program server. In this embodiment the participant has a blood sugar measurement in a predetermined range indicative of the future development of diabetes if the blood sugar measurement remains in the predetermined range or advances into an advanced predetermined range indicative of a higher probability of the future development of diabetes. The participant is also currently receiving an adjunct medical treatment designed to improve the blood sugar measurement if used by the participant per a treatment plan.

In some instances, the method includes providing 2310 to the participant an exercise to be performed by the participant, where the exercise designed to improve the blood sugar measurement if performed by the participant on a frequency designated by the online health improvement program.

The method also preferably includes providing 2315 to the participant a question to be answered by the participant, where the question is designed to determine if the participant is complying with the treatment plan for the adjunct medical treatment. Also, the method includes receiving 2320 a measurement of the participant's blood sugar. For example, the participant may utilize an electronic blood sugar meter that uploads its data to the system 1705. Alternatively, the participant may input their blood sugar numbers into the system 1705 using a mobile application or web-based interface.

Next, the method includes receiving 2325 a response from the participant to the exercise and receiving 2330 an answer from the participant about complying with the treatment plan for the adjunct medical treatment.

After receiving the requisite information, the method includes correlating 2335 by the system 1705 the measurement, the response, and the answer. The correlation allows the system 1705 to execute a step of determining 2340 if the blood sugar measurement remains in the predetermined range, or has advanced into the advanced predetermined range indicative of a higher probability of the future development of diabetes, or has improved into an improved predetermined range indicative of a lower probability of the future development of diabetes.

In some instances, such as when the blood sugar measurement has changed ranges, the method may include the system 1705 determining 2345 whether the change of ranges is caused by the exercise, the adjunct medical treatment or a combination thereof. In other instances, such as when the change of ranges is a change to the improved predetermined range indicative of a lower probability of the future development of diabetes, and the change is caused by the exercise, the method may include the system 1705 halting 2350 the administering of the adjunct medical treatment. Again, this may include, for example, the system 1750 outputting a message to the participant or a third party that the adjunct medical treatment should be stopped.

Provided below is an exemplary combination of a lifestyle intervention program (e.g., health improvement program) with an adjunct medical treatment, such as the administration of a therapeutic drug.

### Example One

Online lifestyle intervention program for diagnosing who should be prescribed metformin for reversing pre-diabetic status.

Type 2 diabetes mellitus, formerly called non-insulin-dependent diabetes mellitus, is a serious, costly disease affecting approximately 8 percent of adults in the United States. Treatment prevents some of its devastating complications, but does not usually restore normoglycemia or eliminate all the adverse consequences. The diagnosis is often delayed until complications are present. Since current methods of treating diabetes remain inadequate, prevention is preferable.

Research (see e.g., Reduction in the Incidence of Type 2 Diabetes with Lifestyle Intervention or Metformin, Diabetes Prevention Program Research Group, N Engl J Med 2002; 346:393-403, Feb. 7, 2002), indicates that type 2 diabetes can be prevented or delayed in persons at high risk for the disease. In the above-cited study, the incidence of diabetes was reduced by 58 percent with lifestyle intervention and by 31 percent with metformin treatment, as compared with placebo. These effects were similar in men and women and in all racial and ethnic groups. The lifestyle intervention was at least as effective in older participants as it was in younger participants. The study showed that treatment with metformin and modification of lifestyle were two highly effective means of delaying or preventing type 2 diabetes. The lifestyle intervention was particularly effective, with one case of diabetes prevented per seven persons treated for three years. After ten years, the incidence of diabetes was 34% lower in the group of participants in the lifestyle intervention group and 18% lower in those given metformin.

In the above-cited study, metformin was less effective in persons with a lower base-line body-mass index or a lower fasting plasma glucose concentration than in those with higher values for these variables. The reduction in the average fasting plasma glucose concentration was similar in the lifestyle-intervention and metformin groups, but the lifestyle intervention had a greater effect than metformin on glycosylated hemoglobin, and a larger proportion of participants in the lifestyle-intervention group had normal post-load glucose values at follow-up. Rates of adverse events, hospitalization, and mortality were similar, except that the rate of gastrointestinal symptoms was highest in the metformin group and the rate of musculoskeletal symptoms was highest in the lifestyle-intervention group.

The above-cited study, however, was not designed to test the relative contributions of dietary changes, increased physical activity, and weight loss to the reduction in the risk of diabetes. Moreover, the study did not determine if the non-responders to lifestyle intervention would respond to metformin treatment.

With the above in mind, in many cases, lifestyle intervention is preferable to metformin treatment due to the avoidance of undesirable side-effects and the higher cost of treatment associated with metformin treatment. For this reason, it is preferable to start individuals on a lifestyle intervention program and only offer metformin treatment to non-responders. Additionally, non-responders to lifestyle intervention should be determined after ascertaining that the non-responder failed to respond to the lifestyle intervention program, and not due to non-compliance with the lifestyle intervention program.

Accordingly, individuals should be first enrolled in the herein described online lifestyle intervention program(s). Eligibility criteria should include an age of at least 25 years, a body-mass index (the weight in kilograms divided by the square of the height in meters) of 24 or higher (22 or higher in Asians), and a plasma glucose concentration of 95 to 125 mg per deciliter (5.3 to 6.9 mmol per liter) in the fasting state (≦125 mg per deciliter in the American Indian clinics) and 140 to 199 mg per deciliter (7.8 to 11.0 mmol per liter) two hours after a 75-g oral glucose load.

The goals for the participants in the exemplary online lifestyle intervention programs as described herein should include achieving and maintaining a weight reduction of at least 7 percent of initial body weight through a healthy low-calorie, low-fat diet and engaging in physical activity of moderate intensity, such as brisk walking, for at least 150 minutes per week. A 16 week lesson curriculum covering diet, exercise, and behavior modification should be offered as part of the exemplary online lifestyle intervention programs.

The exemplary online lifestyle intervention programs described herein should receive, store, monitor and analyze such variables as fasting plasma glucose concentrations, weight, body-mass index, non-fasting plasma glucose concentrations, blood pressure, temperature, heartbeat, exercise activities and the like. As long as a participant's fasting plasma glucose concentration remains less than 140 mg per deciliter, the participant should remain in the online lifestyle intervention program. If the fasting plasma glucose concentration reaches or exceeds 140 mg per deciliter, the participant should initiate metformin treatment while remaining in the online lifestyle intervention program.

Treatment with metformin should be initiated at a dose of 850 mg taken orally once a day. At one month, the dose of metformin should be increased to 850 mg twice daily, unless gastrointestinal symptoms warrant a longer titration period. Metformin is sold under several trade names, including Glucophage XR, Carbophage SR, Riomet, Fortamet, Glumetza, Obimet, Gluformin, Dianben, Diabex, Diaformin, Siofor and Metfogamma. The liquid metformin is sold under the name Riomet. Each 5-ml of Riomet is equivalent to the 500 mg tablet form of metformin. Metformin IR (immediate release) is available in 500 mg, 850 mg, and 1000 mg tablets; all are now generic in the U.S. Medtformin SR (slow release) or XR (extended release) was introduced in 2004. It is available in 500 mg, 750 mg and 1000 mg strengths, mainly to counteract the most common gastrointestinal side effects, as well as to increase compliance by reducing pill burden.

The exemplary online lifestyle intervention programs described herein may pose additional periodic questions to participants on metformin treatment, such as: pill counts; questions about muscle pain or weakness; numb or cold feeling in arms and legs; trouble breathing; feeling dizzy, light-headed, tired, or very weak; stomach pain, nausea with vomiting; or slow or uneven heart rate; feeling short of breath, even with mild exertion; swelling or rapid weight gain; fever, chills, body aches, flu symptoms; headache or muscle pain; symptoms of low blood sugar including sudden sweating, shaking, fast heartbeat, hunger, blurred vision, dizziness, or tingling hands/feet; symptoms of high blood sugar (hyperglycemia) include thirst, increased urination, confusion, drowsiness, flushing, rapid breathing, and fruity breath odor. According to some embodiments, various notifications may be automatically electronically sent to such authorized parties as health care providers.

According to various exemplary embodiments, the online lifestyle intervention program when combined with metformin treatment in former non-responders to the online lifestyle intervention program will produce more favorable, synergistic results than otherwise observed in those participants just receiving metformin treatment. In some situations, after a participant has made significant and/or sustained progress while on metformin treatment and the online lifestyle intervention program, the participant can be taken off metformin treatment while remaining in the online lifestyle intervention program for as long as the participant's condition does not significantly decline. In other situations, non-responders may temporarily or permanently discontinue the online lifestyle intervention program while continuing metformin treatment. Should metformin treatment alone improve the participant's condition in a significant and/or sustained manner, the participant may re-initiate the online lifestyle intervention program with the goal of transitioning off metformin treatment while remaining in the online lifestyle intervention program. Additionally, various components of the online lifestyle intervention program can be used with the various regimens described herein. For example, a non-responder on metformin treatment can use those components of the online lifestyle intervention program designed for monitoring adverse events and/or compliance with metformin treatment while not using other components, such as those designed for physical activities.

FIG. 24 illustrates an exemplary computing device 1 that may be used to implement an embodiment of the present systems and methods. The system 1 of FIG. 24 may be implemented in the contexts of the likes of clients, information display systems, computing devices, terminals, networks, servers, or combinations thereof. The computing device 1 of FIG. 24 includes a processor 10 and main memory 20. Main memory 20 stores, in part, instructions and data for execution by processor 10. Main memory 20 may store the executable code when in operation. The system 1 of FIG. 24 further includes a mass storage device 30, portable storage device 40, output devices 50, user input devices 60, a display system 70, and peripherals 80.

The components shown in FIG. 24 are depicted as being connected via a single bus 90. The components may be connected through one or more data transport means. Processor 10 and main memory 20 may be connected via a local microprocessor bus, and the mass storage device 30, peripherals 80, portable storage device 40, and display system 70 may be connected via one or more input/output (I/O) buses.

Mass storage device 30, which may be implemented with a magnetic disk drive or an optical disk drive, is a non-volatile storage device for storing data and instructions for use by processor 10. Mass storage device 30 can store the system software for implementing embodiments of the present technology for purposes of loading that software into main memory 20.

Portable storage device 40 operates in conjunction with a portable non-volatile storage medium, such as a floppy disk, compact disk or digital video disc, to input and output data and code to and from the computing system 1 of FIG. 24. The system software for implementing embodiments of the present technology may be stored on such a portable medium and input to the computing system 1 via the portable storage device 40.

Input devices 60 provide a portion of a user interface. Input devices 60 may include an alphanumeric keypad, such as a keyboard, for inputting alphanumeric and other information, or a pointing device, such as a mouse, a trackball, stylus, or cursor direction keys. Additionally, the system 1 as shown in FIG. 24 includes output devices 50. Suitable output devices include speakers, printers, network interfaces, and monitors.

Display system 70 may include a liquid crystal display (LCD) or other suitable display device. Display system 70 receives textual and graphical information, and processes the information for output to the display device. Peripherals 80 may include any type of computer support device to add additional functionality to the computing system. Peripherals 80 may include a modem or a router.

The components contained in the computing system 1 of FIG. 24 are those typically found in computing systems that may be suitable for use with embodiments of the present technology and are intended to represent a broad category of such computer components that are well known in the art. Thus, the computing system 1 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method for managing a health condition by using a health program server that comprises a processor and a memory for storing logic that is executed by the processor to perform the method comprising:
tracking performance of a participant in a health improvement program, the health improvement program designed to improve the health condition of the participant;
comparing the performance of the participant to a minimum threshold requirement that signals that the participant is not adequately improving under the health improvement program;
identifying when the performance of the participant falls below the minimum threshold level; and
when the performance of the participant falls below the minimum threshold level, outputting a message to at least one of the participant or a third party that the participant is a potential candidate for an adjunct medical treatment.

2. The method according to claim 1, further comprising administering the adjunct medical treatment to the participant while the participant remains in the health improvement program.

3. The method according to claim 2, further comprising comparing the performance of the participant to a predetermined standard that signals that the participant has significantly improved under the health improvement program and the adjunct medical treatment.

4. The method according to claim 3, further comprising continuing or discontinuing the administering of the adjunct medical treatment to the participant if the predetermined standard signals that the participant has significantly improved under the health improvement program and the adjunct medical treatment.

5. The method according to claim 2, further comprising providing questions to the participant that are designed to elicit responses regarding whether the participant is experiencing adverse effects from the adjunct medical treatment.

6. The method according to claim 1, further comprising providing questions to the participant that are designed to elicit responses regarding the participant's existing medical treatments.

7. The method according to claim 6, further comprising providing questions to the participant that are designed to elicit responses regarding whether the participant is experiencing adverse effects from the existing medical treatments.

8. The method according to claim 6, further comprising correlating an efficacy biomarker to at least one of the participant's existing medical treatments.

9. The method according to claim 8, further comprising receiving a measurement of the participant's efficacy biomarker.

10. The method according to claim 9, further comprising comparing the participant's efficacy biomarker to a predetermined standard.

11. The method according to claim 10, further comprising outputting a message to at least one of the participant or a third party when the participant's efficacy biomarker significantly deviates from the predetermined standard.

12. The method according to claim 11, further comprising adjusting the existing medical treatment corresponding to the participant's efficacy biomarker.

13. The method according to claim 1, wherein the adjunct medical treatment comprises any of a therapeutic drug, a diet, a medical device, a surgery, and combinations thereof.

14. The method according to claim 1, wherein tracking the performance of the participant includes monitoring one or more biometric attributes of the participant.

15. The method according to claim 1, wherein the medical condition comprises any of pre-diabetes, diabetes, pre-hypertension, hypertension, pre-coronary atherosclerosis, and pre-renal failure, and combinations thereof.

16. The method according to claim 11, further comprising adjusting the health improvement program in response to the participant's efficacy biomarker.

17. A method for improving a health condition by using a health program server that comprises a processor and a memory for storing logic that is executed by the processor to perform the method comprising:
enrolling a participant in an online health improvement program managed by the health improvement program server, the participant having a biometric parameter in a predetermined range indicative of a future adverse physical medical condition if the biometric parameter remains in the predetermined range or advances into an advanced predetermined range indicative of a higher probability of development of the future adverse physical medical condition;
providing to the participant after the enrolling an exercise to be performed by the participant, the exercise designed to improve the biometric parameter if performed by the participant on a frequency designated by the online health improvement program;
receiving after the enrolling a measurement of the participant's biometric parameter;
receiving after the enrolling a response from the participant to the exercise,
correlating the measurement to the response and determining if the biometric parameter remains in the predetermined range, or has advanced into the advanced predetermined range indicative of a higher probability of development of the future adverse physical medical condition, or has improved into an improved predetermined range indicative of a lower probability of development of the future adverse medical condition; and
administering an adjunct medical treatment to the participant if the participant's biometric parameter has advanced into the advanced predetermined range indicative of a higher probability of development of the future adverse physical medical condition.

18. The method of claim 17, the method further comprising halting the administering of the adjunct medical treatment to the participant if the participant's biometric parameter has improved into the improved predetermined range indicative of a lower probability of development of the future adverse medical condition.

19. A method for improving a health condition by using a health program server that comprises a processor and a memory for storing logic that is executed by the processor to perform the method comprising:
enrolling a participant in an online health improvement program managed by the health improvement program server, the participant having a biometric parameter in a predetermined range indicative of a future adverse physical medical condition if the biometric parameter remains in the predetermined range or advances into an advanced predetermined range indicative of a higher probability of development of the future adverse physical medical condition, and the participant receiving an adjunct medical treatment designed to improve the biometric parameter if used by the participant per a treatment plan;
providing to the participant after the enrolling an exercise to be performed by the participant, the exercise designed to improve the biometric parameter if performed by the participant on a frequency designated by the online health improvement program;
providing to the participant after the enrolling a question to be answered by the participant, the question designed to determine if the participant is complying with the treatment plan for the adjunct medical treatment;
receiving after the enrolling a measurement of the participant's biometric parameter;
receiving after the enrolling a response from the participant to the exercise;
receiving after the enrolling an answer from the participant about complying with the treatment plan for the adjunct medical treatment;
correlating the measurement, the response, and the answer, and determining if the biometric parameter remains in the predetermined range, or has advanced into the advanced predetermined range indicative of a higher probability of development of the future adverse physical medical condition, or has improved into an improved predetermined range indicative of a lower probability of development of the future adverse medical condition;
if the biometric parameter has changed ranges, further determining whether the change of ranges is caused by the exercise, the adjunct medical treatment or a combination thereof; and
if the change of ranges is a change to the improved predetermined range indicative of a lower probability of development of the future adverse medical condition, and the change is caused by the exercise, halting the administering of the adjunct medical treatment.

20. A method for slowing down or reversing an onset of diabetes by using a health program server that comprises a processor and a memory for storing logic that is executed by the processor to perform the method comprising:
enrolling a participant in an online health improvement program managed by the health improvement program server, the participant having a blood sugar measurement in a predetermined range indicative of the future development of diabetes if the blood sugar measurement remains in the predetermined range or advances into an advanced predetermined range indicative of a higher probability of the future development of diabetes, and the participant receiving an adjunct medical treatment designed to improve the blood sugar measurement if used by the participant per a treatment plan;
providing to the participant after the enrolling an exercise to be performed by the participant, the exercise designed to improve the blood sugar measurement if performed by the participant on a frequency designated by the online health improvement program;
providing to the participant after the enrolling a question to be answered by the participant, the question designed to determine if the participant is complying with the treatment plan for the adjunct medical treatment;
receiving after the enrolling a measurement of the participant's blood sugar;
receiving after the enrolling a response from the participant to the exercise;
receiving after the enrolling an answer from the participant about complying with the treatment plan for the adjunct medical treatment;
correlating the measurement, the response, and the answer, and determining if the blood sugar measurement remains in the predetermined range, or has advanced into the advanced predetermined range indicative of a higher probability of the future development of diabetes, or has improved into an improved predetermined range indicative of a lower probability of the future development of diabetes;
if the blood sugar measurement has changed ranges, further determining whether the change of ranges is caused by the exercise, the adjunct medical treatment or a combination thereof; and
if the change of ranges is a change to the improved predetermined range indicative of a lower probability of the future development of diabetes, and the change is caused by the exercise, halting the administering of the adjunct medical treatment.
